(19) United States
(12) Patent Application Publication
(10) Pub. No.: US 2026/0184614 A1
(43) Pub. Date: Jul. 2, 2026

(54) WASTEWATER TREATMENT METHOD AND APPARATUS

(71) Applicant: EVOLUTION AQUA LIMITED, Wigan, Lancashire (GB)

(72) Inventors: Nicholas Jackson, Wigan (GB); Gavin Haywood, Wigan (GB)

(21) Appl. No.: 19/131,593

(22) PCT Filed: Nov. 21, 2023
(86) PCT No.: PCT/EP2023/082586

§ 371 Date: May 21, 2025

(30) Foreign Application Priority Data
Nov. 21, 2022 (GB) 2217403.1

(51) Int. Cl. C02F 9/00; B01D 24/16; B01D 24/46; C02F 1/00; C02F 1/463; C02F 1/52; C02F 3/00; C02F 3/06; C02F 3/08; C02F 3/12; C02F 101/10

(52) U.S. Cl. CPC C02F 9/00; B01D 24/16; B01D 24/46; C02F 1/004; C02F 2001/007; C02F 1/463; C02F 1/52; C02F 3/005; C02F 3/06; C02F 3/085; C02F 3/1215; C02F 2101/105; C02F 2301/046; C02F 2303/16

(57) ABSTRACT

Aspects of the present invention relate to a wastewater treatment process (100) and a wastewater treatment plant (1) for treating wastewater. The wastewater treatment process (100) comprises receiving wastewater for treatment. The wastewater is supplied to a bioreactor (13) for performing biological filtration of the wastewater. The wastewater is discharged from the bioreactor (13) to a mechanical filter apparatus (15) disposed downstream of the bioreactor (13). The mechanical filter apparatus (15) comprises a static filter pack (75) for filtering solid waste suspended in the wastewater. The static filter pack (75) comprises a plurality of mechanical filter elements (71) each having one or more filter cells (73). The treated wastewater is discharged.

### TECHNICAL FIELD

The present disclosure relates to a wastewater treatment method and apparatus. Aspects of the invention relate to a wastewater treatment process and a wastewater treatment plant. The wastewater may, for example, comprise industrial wastewater and/or municipal wastewater. The wastewater treatment method and apparatus may also be used for treating wastewater in a water reuse application.

### BACKGROUND

It is known to utilise a bioreactor to perform biological filtration of wastewater. The bioreactor may, for example, comprise a filter media which supports colonies of microorganisms which convert organic material present in the wastewater, thereby performing biological filtration. The bioreactor may be configured to support aerobic or anaerobic microorganisms to perform biological filtration. The filter media may comprise a plurality of biological filter elements which may be circulated in the bioreactor (a so-called moving bed bioreactor).

The inventor(s) in the present case have recognised that the movement of the biological filter elements in the bioreactor generates solid particles which are suspended in the wastewater. The movement of the biological filter elements may cause material to be dislodged, for example as the biological filter elements contact each other and/or the sidewalls of the bioreactor. The dislodged matter may comprise accumulated waste filtered from the wastewater and/or clumps of dead microorganisms. The dislodged solid particles may be relatively small in size, less than 5 μm in diameter. The inventor(s) have determined that additional filtration can be performed to remove at least some of the solid particles discharged from the bioreactor. If the biological filter elements are in a static bed, for example in a submerged aerated bed, it has been recognised that material may slough off the surface of the biological filter elements. This may result in solid matter being precipitated into the wastewater, for example in the form suspended particles. Other forms of biological filtration may result in particles and waste matter being introduced into wastewater.

It is an aim of the present invention to address one or more of the disadvantages associated with the prior art.

### SUMMARY OF THE INVENTION

Aspects and embodiments of the invention provide a wastewater treatment process and a wastewater treatment plant as claimed in the appended claims.

According to an aspect of the present invention there is provided a wastewater treatment process for treating wastewater, the wastewater treatment process comprising:
receiving wastewater for treatment;
supplying the wastewater to a bioreactor for performing biological filtration of the wastewater;
supplying the wastewater discharged from the bioreactor to a mechanical filter apparatus disposed downstream of the bioreactor, wherein the mechanical filter apparatus comprises a static filter pack for filtering solid waste suspended in the wastewater, the static filter pack comprising a plurality of mechanical filter elements each having one or more filter cells; and
discharging treated wastewater.

The mechanical filter apparatus comprises a plurality of the mechanical filter elements. The mechanical filter elements form the static filter pack which mechanically filters the wastewater as it passes through the mechanical filter apparatus. The mechanical filter apparatus may comprise a filter tank which forms a filtration chamber in which the mechanical filter elements are disposed. The or each filter cell formed in each mechanical filter element have an open cell structure. The wastewater may flow into the or each filter cell. The mechanical filtration is performed by promoting settlement of particles in the or each filter cell.

The bioreactor may comprise a biological filter media for performing biological filtration of the wastewater. The biological filter media may comprise a plurality of biological filter elements for supporting colonies of microorganisms on a surface of the biological filter media to perform biological filtration of the wastewater. The biological filter elements may be circulated within the bioreactor, i.e. forming a moving bed biological filter. Alternatively, the biological filter elements may be static within the bioreactor, i.e. forming a static bed biological filter. Other types of bioreactor are contemplated. For example, the bioreactor may not comprise biological filter media.

The static filter pack in the mechanical filter apparatus is operative to filter the solid waste discharged from the bioreactor. The solid waste may be dislodged from the surface of the biological filter elements in the bioreactor. The solid waste may be dislodged when the biological filter elements in a moving bed contact each other. The solid waste may be dislodged when the biological filter elements form a static bed biological filter. Other mechanical, hydraulic or biological processes may cause the solid waste to be dislodged from the biological filter elements. The solid waste may be suspended in the wastewater discharged from the bioreactor.

The biological filter elements may be static within the bioreactor during biological filtration. Alternatively, the biological filter elements may be circulated within the bioreactor during biological filtration. The circulation of the biological filter elements may cause solid waste to be dislodged from the biological filter elements and suspended in the wastewater discharged from the bioreactor. The solid waste may comprise waste from the wastewater and/or clumps of microorganisms separated from the biological filter elements.

The process may comprise supplying the wastewater to a first settlement tank for settlement of solids. The first settlement tank may be located upstream of the bioreactor; and supplying the wastewater from the first settlement tank to the bioreactor.

The process may comprise supplying the wastewater from the bioreactor to a second settlement tank for settlement of solids. The second settlement tank may be located downstream of the bioreactor. The wastewater from the settlement tank may be supplied to the mechanical filter apparatus.

The process may comprise introducing pressurised air into the bioreactor to circulate the biological filter media within the bioreactor. Alternatively, or in addition, a mechanical stirrer may be provided to agitate the biological filter media within the bioreactor.

The process may comprise periodically cleaning the mechanical filter apparatus to remove solid waste accumulated in the static filter pack. The cleaning of the mechanical filter apparatus may comprise disrupting the static filter pack to dislodge the solid waste accumulated in the mechanical filter elements.

A waste outlet may be opened to discharge accumulated waste from the mechanical filter apparatus. The accumulated waste may be discharged during a cleaning option. The process may comprise disrupting the static filter pack, for example during a cleaning operation. Optionally, a mechanical filter apparatus inlet for receiving wastewater from the bioreactor and a mechanical filter apparatus outlet for discharging the treated wastewater from the mechanical filter apparatus may be opened.

The process may comprise introducing a pressurised fluid into the mechanical filter apparatus to disrupt the static filter pack. The fluid may be introduced at a pressure greater than atmospheric pressure. The fluid may, for example, be air or water. Alternatively, air may be drawn in the mechanical filter apparatus as liquid is drained from the mechanical filter apparatus. The air may be introduced into the mechanical filter apparatus periodically, for example during a cleaning operation to clean the mechanical filter elements. Alternatively, or in addition, a backwashing liquid may be introduced into the mechanical filter apparatus to clean the mechanical filter elements.

The process may comprise opening a mechanical filter apparatus waste outlet to discharge at least some of the accumulated solid waste from the mechanical filter apparatus. At least some of the wastewater in the mechanical filter apparatus may be discharged with the accumulated solid waste. At least some of the accumulated solid waste from the mechanical filter apparatus may be re-circulated through the bioreactor. The solid waste may be dislodged from the mechanical filter elements, for example dislodged from a surface of the mechanical filter elements and/or from the one or more filter cells formed therein. At least some of the solid waste dislodged from the mechanical filter elements may be re-circulated through the bioreactor and undergo further biological treatment. The accumulated solid waste may be introduced directly into the bioreactor or upstream of the bioreactor. The accumulated solid waste may, for example, be introduced into a settlement tank upstream of the bioreactor.

The process may comprise agglomerating matter suspended in the wastewater. The process may comprise using an electrocoagulation unit to agglomerate matter suspended in the wastewater. The electrocoagulation unit may be located upstream of the mechanical filter apparatus. The agglomerated matter may be suspended in the wastewater introduced into the mechanical filter apparatus.

The electrocoagulation unit may be located downstream of the bioreactor. The electrocoagulation unit may agglomerate the solid waste discharged from the bioreactor. The solid waste may be dislodged from a surface of biological filter elements provided in the bioreactor.

Alternatively, or in addition, the electrocoagulation unit may be incorporated into the mechanical filter apparatus. The solid matter (typically particles) may agglomerate inside the mechanical filter apparatus, thereby helping to ensure they remain intact. The electrocoagulation unit may comprise one or more electrode to support an electrochemical process. The one or more electrode may be disposed inside the mechanical filter apparatus, for example inside the filter chamber in which the static filter pack is formed. The one or more electrode may be at least partially surrounded by the mechanical filter elements forming the static filter pack. The one or more electrode may be sacrificial. By agglomerating the solid matter (typically particles) in the mechanical filter apparatus, decomposition or degradation of the agglomerated matter may be reduced. The at least one electrocoagulation unit may cause matter to agglomerate directly into the static filter pack.

The process may comprise introducing a coagulating agent into the wastewater. The coagulating agent may cause flocs to form in the wastewater. The flocs may comprise or consist of loosely aggregated particles or soft flakes. The coagulating agent may be introduced into the wastewater upstream of the mechanical filter apparatus. Alternatively, or in addition, the coagulating agent may be introduced into the wastewater inside the mechanical filter apparatus. For example, the coagulating agent may be introduced into the filter chamber in the mechanical filter apparatus in which the static filter pack is formed. The coagulating agent may be introduced directly into the filter chamber or may be introduced at an inlet to the filter chamber. A coagulating dosing system may be provided to deliver the coagulating agent. The coagulating dosing system may deliver a metered dose of the coagulating agent. The coagulating agent may be introduced as a liquid or a solid, for example comprising granules or powder.

The coagulating agent may cause phosphate dissolved in the wastewater to come out of solution and form particles. The coagulating agent may be Ferric Chloride or Poly Aluminium Sulphate (PAC). The coagulating agent may cause the particles comprising or consisting of phosphate to agglomerate. The coagulating agent may cause the particles comprising or consisting of phosphate to agglomerate and form flocs. At least some of the flocs may be suspended in the wastewater. The static filter pack of the mechanical filter apparatus may filter at least some of the particles, flocs and agglomerated matter from the wastewater.

At least in certain embodiments, the flow of wastewater through the mechanical filter apparatus is substantially constant. The process may comprise performing single-pass mechanical filtration of the wastewater in the mechanical filter apparatus (i.e., the wastewater is passed through the mechanical filter apparatus once). Alternatively, the process may comprise performing multi-pass mechanical filtration of the wastewater in the mechanical filter apparatus (i.e., the wastewater is passed through the mechanical filter apparatus a plurality of times). A conduit may be provided to re-circulate the wastewater through the mechanical filter apparatus.

The process may comprise establishing a flow rate per unit cross-sectional area of the static filter pack formed in the mechanical filter apparatus in the range 0.1 m3/m2/h to 19 m3/m2/h; 5 m3/m2/h to 19 m3/m2/h; or 11 m3/m2/h to 19 m3/m2/h.

According to a further aspect of the present invention there is provided a wastewater treatment plant for treating wastewater, the wastewater treatment plant comprising:
an inlet for receiving wastewater for treatment;
a bioreactor comprising a biological filter media for performing biological filtration of the wastewater; and
a mechanical filter apparatus disposed downstream of the bioreactor, wherein the mechanical filter apparatus comprises a static filter pack for filtering solid waste suspended in the wastewater, the static filter pack comprising a plurality of mechanical filter elements each having one or more filter cells; and
an outlet for discharging treated wastewater.

The mechanical filter apparatus comprises a plurality of the mechanical filter elements. The mechanical filter elements form the static filter pack which, in use, mechanically filters the wastewater as it passes through the mechanical filter apparatus. The mechanical filter apparatus may comprise a filter tank which forms a filtration chamber in which the mechanical filter elements are disposed. The or each filter cell formed in each mechanical filter element have an open cell structure. In use, the wastewater flows into the or each filter cell. The mechanical filtration is performed by promoting settlement of particles in the or each filter cell.

The bioreactor may comprise a biological filter media for performing biological filtration of the wastewater. The biological filter media may comprise a plurality of biological filter elements for supporting colonies of microorganisms on a surface of the biological filter media to perform biological filtration of the wastewater. The biological filter elements may be circulated within the bioreactor, i.e. forming a moving bed biological filter. Alternatively, the biological filter elements may be static within the bioreactor, i.e. forming a static bed biological filter. Other types of bioreactor are contemplated. For example, the bioreactor may not comprise biological filter media.

In use, the static filter pack in the mechanical filter apparatus filters the solid waste discharged from the bioreactor. The solid waste may be dislodged from the surface of the biological filter elements in the bioreactor. The solid waste may be dislodged when the biological filter elements in a moving bed contact each other. The solid waste may be dislodged when the biological filter elements form a static bed biological filter. Other mechanical, hydraulic or biological processes may cause the solid waste to be dislodged from the biological filter elements. The solid waste may be suspended in the wastewater discharged from the bioreactor.

The wastewater treatment plant may comprise a first settlement tank for promoting settlement of solids suspended in the wastewater, the first settlement tank being located upstream of the bioreactor.

Alternatively, or in addition, the wastewater treatment plant may comprise a second settlement tank for promoting settlement of solids suspended in the wastewater, the second settlement tank being located downstream of the bioreactor. The second settlement tank may be located between the bioreactor and the mechanical filter apparatus. Alternatively, the mechanical filter apparatus may be disposed inside the second settlement tank. For example, the mechanical filter apparatus may be disposed proximal to a downstream outlet of the second settlement tank. The wastewater may pass through the mechanical filter apparatus as it is discharged from the second settlement tank.

The wastewater treatment plant may optionally comprise means for circulating the biological filter elements within the bioreactor during filtration. The means may comprise a mechanical stirrer disposed in the bioreactor. Alternatively, the means may comprise a pump for introducing a pressurised liquid or air into the bioreactor. The pressurised liquid or air may circulate the biological filter media within the bioreactor. In use, the circulation of the biological filter elements may cause solid waste to be dislodged from the biological filter elements and suspended in the wastewater discharged from the bioreactor. In a variant, the wastewater treatment plant may comprise a pump for introducing air into the bioreactor to form a (submerged) static bed biological filter comprising a plurality of the biological filter elements.

The wastewater treatment plant may optionally comprise means for disrupting the static filter pack in the mechanical filter apparatus to dislodge the solid waste accumulated in the mechanical filter elements. The means may comprise one or more of the following: a pump for introducing pressurised air into the static filter pack; a pump for introducing pressurised liquid into the static filter pack; a mechanical stirrer for stirring the mechanical filter elements.

The wastewater treatment plant may comprise one or more valves for closing at least one of a mechanical filter apparatus inlet and a mechanical filter apparatus outlet while the static filter pack is disrupted.

The wastewater treatment plant may comprise a pump for supplying pressurised fluid, for example water or air, into the mechanical filter apparatus to disrupt the static filter pack. The wastewater treatment plant may comprise a mechanical filter apparatus waste outlet operable to discharge at least some of the solid waste accumulated in the mechanical filter apparatus. The mechanical filter apparatus waste outlet may be operable to discharge at least some of the solid waste dislodged from the mechanical filter elements.

The wastewater treatment plant may comprise a return line configured to return at least some of the solid waste accumulated in the mechanical filter apparatus to the bioreactor. The return line may be configured to introduce the waste into the bioreactor or upstream of the bioreactor. The return line may be connected to the bioreactor to return the solid waste dislodged from the mechanical filter elements directly into the bioreactor. The return line may be connected to the first settlement tank to return the solid waste accumulated in the mechanical filter apparatus to the first settlement tank.

The wastewater treatment plant may comprise at least one electrocoagulation unit to agglomerate matter suspended in the wastewater. The at least one electrocoagulation unit may be located upstream of the mechanical filter apparatus. In use, the agglomerated matter may be suspended in the wastewater introduced into the mechanical filter apparatus. The at least one electrocoagulation unit may be located downstream of the bioreactor. In use, the at least one electrocoagulation unit may be operative to agglomerate solid waste suspended in the wastewater discharged from the bioreactor.

Alternatively, or in addition, the at least one electrocoagulation unit may be integrated into the mechanical filter apparatus. For example, the at least one electrocoagulation unit may be disposed inside the filter chamber in which the mechanical filter elements form a static filter pack. The at least one electrocoagulation unit may be at least partially surrounded by the mechanical filter elements in the static filter pack. The at least one electrocoagulation unit may cause matter to agglomerate directly into the static filter pack.

The wastewater treatment plant may comprise at least one coagulating dosing system for introducing a coagulating agent into the wastewater upstream of the mechanical filter apparatus. The coagulating agent may cause flocs to form in the wastewater. The flocs may comprise or consist of loosely aggregated particles or soft flakes. In use, the coagulating agent may cause phosphate dissolved in the wastewater to come out of solution and form particles. The static filter pack of the mechanical filter apparatus may be configured to filter the particles or agglomerated matter formed by the coagulating agent. The coagulating agent may Ferric Chloride or Poly Aluminium Sulphate PAC. Particles comprising or consisting of phosphate may agglomerate. In use, particles comprising or consisting of phosphate may agglomerate to form flocs. At least some of the flocs may be suspended in the wastewater. The static filter pack of the mechanical filter apparatus is configured to filter the flocs from the wastewater.

At least in certain embodiments, the flow of wastewater through the mechanical filter apparatus is substantially constant. The process may comprise performing single-pass mechanical filtration of the wastewater in the mechanical filter apparatus (i.e., the wastewater is passed through the mechanical filter apparatus once). Alternatively, the process may comprise performing multi-pass mechanical filtration of the wastewater in the mechanical filter apparatus (i.e., the wastewater is passed through the mechanical filter apparatus a plurality of times). A conduit may be provided to re-circulate the wastewater through the mechanical filter apparatus.

The wastewater treatment plant may comprise at least one pump for pumping the wastewater through the mechanical filter apparatus. The at least one pump may be configured to establish a flow rate per unit cross-sectional area of the static filter pack formed in the mechanical filter apparatus in the range 0.1 m3/m2/h to 19 m3/m2/h; 5 m3/m2/h to 19 m3/m2/h; or 11 m3/m2/h to 19 m3/m2/h.

According to an aspect of the present invention there is provided a wastewater treatment process for treating wastewater, the wastewater treatment process comprising:
receiving wastewater for treatment;
supplying the wastewater to a bioreactor comprising a biological filter media for performing biological filtration of the wastewater, the biological filter media comprising a plurality of biological filter elements for supporting colonies of microorganisms, wherein the biological filter elements are circulated within the bioreactor during filtration, the circulation of the biological filter elements causing solid waste to be dislodged from the biological filter elements and suspended in the wastewater;
supplying the wastewater discharged from the bioreactor to a mechanical filter apparatus disposed downstream of the bioreactor, wherein the mechanical filter apparatus comprises a static filter pack for filtering the solid waste dislodged from the biological filter elements in the bioreactor and suspended in the wastewater, the static filter pack comprising a plurality of mechanical filter elements each having one or more filter cells; and
discharging treated wastewater.

It has been recognised that the operation of the bioreactor generates solid waste, for example comprising or consisting of solid particles or flocs. The flocs discharged from the bioreactor may comprise a flocculant mass. The solid waste is dislodged from the surface of the biological filter media as it circulates within the bioreactor. In particular, the biological filter media contact each other causing the solid waste to be dislodged. The dislodged solid waste may be suspended in the wastewater discharged from the bioreactor, for example as solid particles. It has been determined that the mechanical filter apparatus comprising a static filter pack formed by the plurality of mechanical filter elements is particularly effective in the removal of the solid waste suspended in the wastewater discharged from the bioreactor. At least in certain embodiments, the combination of the bioreactor and the mechanical filter apparatus in series has been determined to be particularly effective in the treatment of wastewater. The wastewater may be industrial wastewater or municipal wastewater, for example.

The bioreactor may be anaerobic or aerobic. An anaerobic bioreactor is configured to support anaerobic microorganisms. An aerobic bioreactor is configured to support aerobic microorganisms. An aerobic bioreactor may, for example, be configured to introduce air into the wastewater to support the aerobic microorganisms.

The mechanical filter elements each have one or more filter cells. The structure of the mechanical filter elements is referred to herein as an open-cell structure. The filter elements are non-porous. The sidewalls of the or each filter cells are non-porous. The one or more filter cells each comprise an aperture formed in the mechanical filter elements. The filter elements may be moulded, for example from a plastics material.

The or each filter cell may have a cross-sectional area in the range one (1) to ten (10) square millimetres; or one (1) to five (5) square millimetres. The filter cells may have a length greater than or equal to five (5) millimetres, six (6) millimetres or eight (8) millimetres. The mechanical filter elements may have a negative buoyancy, a neutral buoyancy or a positive buoyancy.

The wastewater treatment process may comprise supplying the wastewater to a settlement tank located upstream of the bioreactor for settlement of solids. The wastewater from the settlement tank may be supplied to the bioreactor.

The wastewater treatment process may comprise introducing pressurised fluid into the bioreactor to circulate the biological filter media within the bioreactor The fluid may be a liquid or a gas. The wastewater treatment process may comprise introducing pressurised air into the bioreactor to circulate the biological filter media within the bioreactor. Alternatively, or in addition, a mechanical stirrer may be used to circulate the biological filter media within the bioreactor. The mechanical stirrer may comprise one or more rotating members, for example.

The wastewater treatment process may comprise periodically cleaning the mechanical filter apparatus to remove solid waste accumulated in the static filter pack. The cleaning of the mechanical filter apparatus may comprise disrupting the static filter pack to dislodge the solid waste accumulated in the mechanical filter elements. The method may comprise disrupting the static filter pack after closing at least one of: a mechanical filter apparatus inlet for receiving wastewater from the bioreactor; and a mechanical filter apparatus outlet for discharging the treated wastewater from the mechanical filter apparatus. The cleaning may comprise disrupting the static filter pack for a predetermined time period.

The static filter pack may be disrupted using one or more mechanical cleaning member. The one or more mechanical cleaning member may be driven by an electric motor or the like. For example, the one or more mechanical cleaning member may be rotated within the mechanical filter apparatus. Alternatively, or in addition, a fluid may be introduced into the mechanical filter apparatus to disrupt the static filter pack. The fluid may be a liquid or a gas. The fluid may be introduced at a pressure greater than atmospheric pressure. The fluid may be air. An air pump may be provided for supplying pressurised air to the mechanical filter apparatus.

The wastewater treatment process may comprise opening a mechanical filter apparatus waste outlet to discharge at least some of the wastewater in the mechanical filter apparatus along with the solid waste dislodged from the mechanical filter elements. The mechanical filter apparatus waste outlet may be opened after the disrupting the static filter pack for a predetermined time period.

The wastewater treatment process may comprise re-circulating at least some of the wastewater through the bioreactor. At least some of the solid waste dislodged from the mechanical filter elements in the mechanical filter apparatus may be re-introduced upstream of the bioreactor. The solid waste accumulated in the mechanical filter apparatus may thereby undergo further biological filtration. The solid waste dislodged from the mechanical filter elements may introduced directly into the bioreactor. Alternatively, the solid waste dislodged from the mechanical filter elements may be introduced upstream of the bioreactor, for example into a settlement tank (if present in the system).

The dislodged solid waste is preferably transported with the wastewater discharged from the mechanical filter apparatus. Alternatively, or in addition, the dislodged solid waste may be transported with a separate liquid supply, for example a cleaning liquid.

The wastewater treatment process may comprise using an electrocoagulation unit to agglomerate matter suspended in the wastewater. The electrocoagulation unit may be located upstream of the mechanical filter apparatus. The agglomerated matter may be suspended in the wastewater introduced into the mechanical filter apparatus. At least in certain embodiments, the mechanical filter apparatus is operative to remove the agglomerated matter from the wastewater.

The electrocoagulation unit may be located downstream of the bioreactor. The electrocoagulation unit may be operative to agglomerate the solid waste dislodged from the biological filter elements in the bioreactor. The agglomerate matter may subsequently be removed by the mechanical filter apparatus.

According to a further aspect of the present invention there is provided a wastewater treatment process for treating wastewater, the wastewater treatment process comprising:
receiving wastewater for treatment;
supplying the wastewater to a bioreactor comprising a biological filter media for performing biological filtration of the wastewater, the biological filter media comprising a plurality of biological filter elements for supporting colonies of microorganisms, wherein the biological filter elements are circulated within the bioreactor during filtration, the circulation of the biological filter elements causing solid waste to be dislodged from the biological filter elements and suspended in the wastewater;
supplying the wastewater discharged from the bioreactor to an electrocoagulation unit to agglomerate the solid waste dislodged from the biological filter elements in the bioreactor; and
discharging treated wastewater.

The microorganisms may be aerobic microorganisms or anaerobic microorganisms. The biological filter elements may be circulated continuously within the bioreactor to maintain appropriate ambient conditions to support the microorganisms in the bioreactor.

According to a further aspect of the present invention there is provided a wastewater treatment process for treating wastewater, the wastewater treatment process comprising:
receiving wastewater for treatment;
supplying the wastewater to an electrocoagulation unit to agglomerate solid matter suspended in the wastewater;
supplying the wastewater from the electrocoagulation unit to a mechanical filter apparatus, wherein the mechanical filter apparatus comprises a static filter pack for filtering the agglomerated solid matter from the electrocoagulation unit, the static filter pack comprising a plurality of mechanical filter elements each having one or more filter cells; and
discharging treated wastewater.

According to a further aspect of the present invention there is provided a wastewater treatment plant for treating wastewater, the wastewater treatment plant comprising:
an inlet for receiving wastewater for treatment;
a bioreactor comprising a biological filter media for performing biological filtration of the wastewater, the biological filter media being suitable for supporting colonies of microorganisms, the bioreactor comprising means for circulating the biological filter media within the bioreactor during filtration; and
a mechanical filter apparatus disposed downstream of the bioreactor, wherein the mechanical filter apparatus comprises a static filter pack for filtering the solid waste dislodged from the biological filter elements in the bioreactor and suspended in the wastewater, the static filter pack comprising a plurality of mechanical filter elements each having one or more filter cells; and
an outlet for discharging treated wastewater.

The microorganisms may be aerobic microorganisms, anaerobic microorganisms or anoxic microorganisms.

The mechanical filter elements each comprise one or more filter cells. The mechanical filter elements are non-porous. The sidewalls of the or each filter cell are non-porous. The one or more filter cells each comprise an aperture formed in the mechanical filter elements. The mechanical filter elements may be moulded, for example from a plastics material.

The wastewater treatment plant may comprise a settlement tank for promoting settlement of solids suspended in the wastewater, the settlement tank being located upstream of the bioreactor.

The wastewater treatment plant may comprise a pressurised air supply for introducing pressurised air into the bioreactor to circulate the biological filter media within the bioreactor. The wastewater treatment plant may comprise an air pump for generating the pressurised air supply.

The wastewater treatment plant may comprise means for disrupting the static filter pack in the mechanical filter apparatus to dislodge the solid waste accumulated in the open cell filter media. The disrupting means may comprise a mechanical member or a stirring mechanism for disrupting the static filter pack. Alternatively, or in addition, the disrupting means may comprise a pump or a compressor for supplying a pressurised fluid into the mechanical filter apparatus. The fluid may comprise a liquid or a gas. The pump or compressor may supply pressurised air to the mechanical filter apparatus.

The wastewater treatment plant may comprise one or more valves for closing at least one of: a mechanical filter apparatus inlet; and a mechanical filter apparatus outlet. The at least one of the mechanical filter apparatus inlet and/or the mechanical filter apparatus outlet may be closed while the static filter pack is disrupted for cleaning.

The wastewater treatment plant may comprise a pump for introducing pressurised air or liquid into the mechanical filter apparatus to disrupt the static filter pack. Alternatively, or in addition, the wastewater treatment plant may comprise a mechanical stirrer for disrupting the static filter pack.

The wastewater treatment plant may comprise a mechanical filter apparatus waste outlet operable to discharge at least some of the wastewater in the mechanical filter apparatus.

The wastewater treatment plant may comprise a return line configured to return at least some of the wastewater and/or accumulated waste from the mechanical filter apparatus for re-introduction into the wastewater treatment plant upstream of the bioreactor. The return line may be connected to the bioreactor to return the wastewater and/or accumulated waste from the mechanical filter apparatus into the bioreactor. The return line may be connected to a settlement tank to return the wastewater from the mechanical filter apparatus into a settlement tank upstream of the bioreactor. The water from the settlement tank may subsequently be discharged into the bioreactor.

The wastewater treatment plant may comprise an electrocoagulation unit to agglomerate matter suspended in the wastewater.

The electrocoagulation unit may be located upstream of the mechanical filter apparatus. In use, the agglomerated matter is suspended in the wastewater which is then introduced into the mechanical filter apparatus.

The electrocoagulation unit may be located downstream of the bioreactor. In use, the electrocoagulation unit may be operative to agglomerate solid waste suspended in the wastewater discharged from the bioreactor.

According to a further aspect of the present invention there is provided a wastewater treatment plant for treating wastewater, the wastewater treatment plant comprising:
an inlet for receiving wastewater for treatment;
a bioreactor comprising a biological filter media for performing biological filtration of the wastewater, the biological filter media being suitable for supporting colonies of microorganisms, the bioreactor comprising means for circulating the biological filter media within the bioreactor during filtration; and
an electrocoagulation unit disposed downstream of the bioreactor, the electrocoagulation unit being configured to agglomerate matter suspended in the wastewater discharged from the bioreactor.

According to a further aspect of the present invention there is provided a wastewater treatment plant for treating wastewater, the wastewater treatment plant comprising:
an inlet for receiving wastewater for treatment;
an electrocoagulation unit to agglomerate solid matter suspended in the wastewater; and
a mechanical filter apparatus disposed downstream of the electrocoagulation unit, wherein the mechanical filter apparatus comprises a static filter pack for filtering the agglomerated solid matter discharged from the electrocoagulation unit and suspended in the wastewater, the static filter pack comprising a plurality of mechanical filter elements each having one or more filter cells; and
an outlet for discharging treated wastewater.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a water treatment plant in accordance with an embodiment of the present invention;

FIG. 2A shows a perspective view of a mechanical filter element for use in a filtration apparatus of the water treatment plant shown in FIG. 1;

FIG. 2B shows an end view of the mechanical filter element shown in FIG. 2A;

FIG. 2C shows a perspective view of a variant of the mechanical filter element shown in FIG. 2A;

FIG. 3 shows a first flow diagram illustrating operation of the wastewater treatment plant shown in FIG. 1;

FIG. 4 shows a schematic representation of a further embodiment of a water treatment plant in accordance with the present invention;

FIG. 5 shows a schematic representation of a further embodiment of a water treatment plant in accordance with the present invention;

FIG. 6 shows a schematic representation of a further embodiment of a water treatment plant in accordance with the present invention;

FIG. 7 shows a second flow diagram illustrating operation of the wastewater treatment plant shown in FIG. 6;

FIG. 8 shows a schematic representation of a further embodiment of a water treatment plant in accordance with the present invention incorporating first and second chemical dosing systems;

FIG. 9 shows a schematic representation of a further embodiment of a water treatment plant in accordance with the present invention incorporating three chemical dosing systems;

FIG. 10 shows examples of filter tanks suitable for the mechanical filter apparatus according to the present invention.

### DETAILED DESCRIPTION

A method and apparatus for treating wastewater in accordance with an embodiment of the present invention is described herein with reference to the accompanying Figures. The wastewater in the present embodiment is municipal wastewater. Alternatively, or in addition, the wastewater treatment plant and the wastewater treatment process could be used to process industrial wastewater.

A wastewater treatment plant 1 in accordance with the present embodiment will now be described. The wastewater treatment plant 1 is a municipal wastewater treatment plant configured to clean municipal wastewater. As described herein, the wastewater treatment plant 1 employs physical and biological methods to clean the wastewater. The wastewater treatment plant 1 may optionally also use chemical methods to clean the wastewater. The wastewater treatment plant 1 cleans the wastewater to remove contaminants or toxins which may result in environmental degradation if released. The wastewater treatment plant 1 may also remove dissolved nutrients, such as nitrogen, to reduce or prevent eutrophication of waterways. The nitrogen may be removed through a denitrification process to convert ammonia to nitrate. In certain embodiments, the wastewater treatment plant 1 may be used to treat industrial wastewater having a higher toxicity than municipal wastewater. The wastewater treatment plant 1 may comprise a pre-treatment facility (not shown) or a post-treatment facility, for example suitable for treating industrial wastewater to remove toxins.

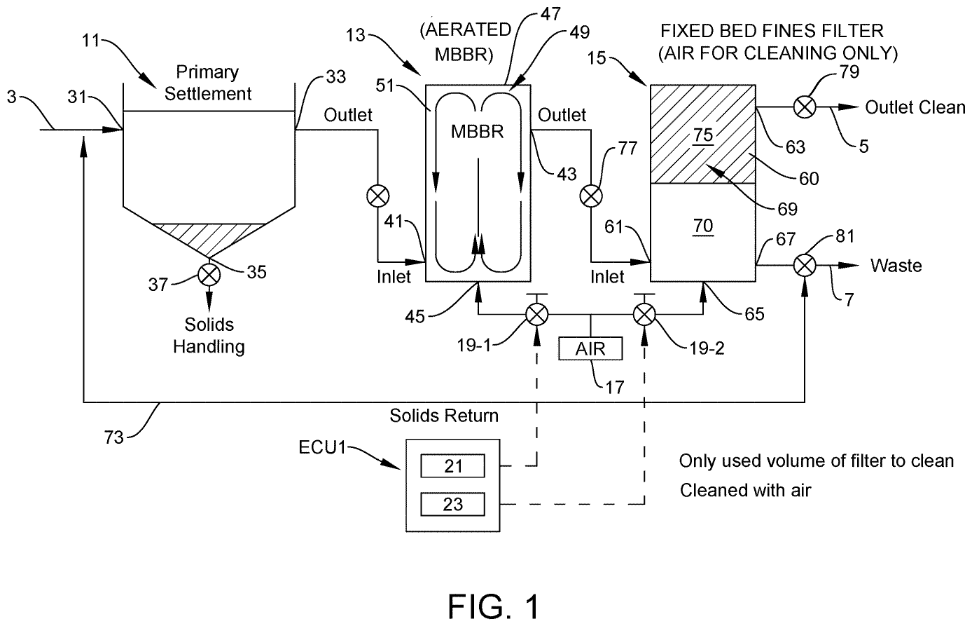

As shown in FIG. 1, the wastewater treatment plant 1 comprises a wastewater inlet 3; a wastewater outlet 5; and a waste outlet 7. The wastewater inlet 3 is configured to receive influent wastewater. The wastewater outlet 5 is configured to discharge the wastewater after treatment by the wastewater treatment plant 1. The waste outlet 7 discharges waste material removed from the wastewater. The waste discharged from the wastewater treatment plant 1 through the waste outlet 7 may undergo further treatment. Alternatively, at least some of the waste may be recirculated through the wastewater treatment plant 1 for further treatment.

The wastewater treatment plant 1 comprises a settlement tank 11, a bioreactor 13, a mechanical filter apparatus 15 and at least one air pump 17. As described herein, the bioreactor 13 is provided to perform biological filtration of the wastewater. The bioreactor 13 in the present embodiment is a moving bed bioreactor, but other types of bioreactor are contemplated. The mechanical filter apparatus 15 is provided to perform mechanical filtration to remove particles suspended in the wastewater discharged from the bioreactor 13. The settlement tank 11, the bioreactor 13 and the mechanical filter apparatus 15 are connected in series. The wastewater is passed through the settlement tank 11, the bioreactor 13 and the mechanical filter apparatus 15 in sequence. In particular, the influent wastewater is introduced into the settlement tank 11 for primary settlement. The wastewater discharged from the settlement tank 11 is introduced into the bioreactor 13 for biological filtration. The wastewater discharged from the bioreactor 13 is introduced into the mechanical filter apparatus 15 for mechanical filtration. The wastewater is discharged from the wastewater treatment plant 1 after passing through the mechanical filter apparatus 15. One or more water pumps (not shown) may be provided to pump the wastewater through the wastewater treatment plant 1. The at least one air pump 17 is provided to supply air at a pressure greater than atmospheric pressure to the bioreactor 13 and the mechanical filter apparatus 15. In the present embodiment, the wastewater treatment plant 1 comprises a single air pump 17 and first and second control valves 19-1, 19-2 are provided to control the supply of pressurised air to at least one of the bioreactor 13 and the mechanical filter apparatus 15 respectively. The wastewater treatment plant 1 comprises an electronic control unit ECU1 comprising at least one electronic processor 21 and a system memory 23. The electronic control unit ECU1 is configured to control operation of the wastewater treatment plant 1 in accordance with the method(s) described herein. The electronic control unit ECU1 is configured to control operation of the first and second control valves 19-1, 19-2 to control the supply of pressurised air from the air pump 17 to the bioreactor 13 and the mechanical filter apparatus 15. In a variant, separate air pumps 17 may be provided to supply air to the bioreactor 13 and the mechanical filter apparatus 15 respectively.

The settlement tank 11 comprises at least one settlement tank inlet 31, at least one settlement tank outlet 33 and at least one settlement tank waste outlet 35. As shown in FIG. 1, the at least one settlement tank inlet 31 and the at least one settlement tank outlet 33 are disposed in an upper region of the settlement tank 11. The at least one settlement tank waste outlet 35 is disposed in a lower region of the settlement tank 11. The settlement tank inlet 31 is in fluid communication with the wastewater inlet 3 of the wastewater treatment plant 1. In use, influent wastewater is introduced into the settlement tank 11 through the at least one settlement tank inlet 31. Solid material precipitates from the wastewater and sinks to the bottom of the settlement tank 11. The wastewater is discharged from the settlement tank 11 through the at least one settlement tank outlet 33 to the bioreactor 13. The settlement tank 11 thereby functions as a pre-filter for the bioreactor 13. At least one settlement tank waste valve 37 is provided for controlling the discharge of solids and waste through the settlement tank waste outlet 35. The waste discharged from the at least one settlement tank 11 is typically in the form of a sludge. The at least one settlement tank waste valve 37 is selectively opened to expel accumulated waste. The waste expelled from the at least one settlement tank 11 is sent to waste or for further treatment. The ECU 1 is configured to control operation of the at least one settlement tank waste valve 37. A wastewater control valve (not shown) may optionally be provided to control the discharge of wastewater from the settlement tank 11 through the at least one settlement tank outlet 33.

The bioreactor 13 comprises at least one bioreactor inlet 41, at least one bioreactor outlet 43 and at least one bioreactor air inlet 45. The at least one bioreactor inlet 41 is in fluid communication with the at least one settlement tank outlet 33. In use, the wastewater from the settlement tank 11 is introduced into the bioreactor 13 through the at least one bioreactor inlet 41. The at least one bioreactor inlet 41 is disposed in a lower region of the bioreactor 13; and the at least one bioreactor outlet 43 is disposed in an upper region of the bioreactor 13. This arrangement is appropriate for the bioreactor 13 in the present embodiment in which an up-flow of wastewater is established. The relative position of the at least one bioreactor inlet 41 and the at least one bioreactor outlet 43 may be reversed if the bioreactor 13 is configured to establish a down-flow of wastewater. The bioreactor 13 performs biological filtration of the wastewater. In particular, the bioreactor 13 comprises a biological filtration chamber 47 containing a biological filter media 49 for performing biological filtration of the wastewater. The biological filter media 49 comprises a plurality of biological filter elements 51. The inner and outer surfaces of the biological filter elements 51 are suitable for supporting colonies of microorganisms. The microorganisms are effective in converting the organic material present in the wastewater. The open cell form of the biological filter elements 51 in the present embodiment provides an increased surface area for supporting the microorganisms. The microorganisms in the present embodiment are aerobic. In a variant, the bioreactor 13 may be configured to support anaerobic or anoxic microorganisms. A biofilm may form on the surface of the biological filter elements 51. Other types of bioreactor 13 are contemplated. For example, the bioreactor 13 may comprise a static bed bioreactor 13. The bioreactor 13 may, for example, comprise a submerged aerated filter (SAF). The biological filter elements 51 form a bed which is continuously aerated. The biological filter elements 51 are at least substantially static in the bed. The biological filter elements 51 may be held in place by one or more screens. The submerged aerated filter may comprise an integrated settlement tank, for example in the form of a settlement chamber formed before an outlet of the submerged aerated filter. In a variant, the bioreactor 13 may not contain a biological filter media. For example, activated sludge from downstream of the bioreactor 13 may be re-introduced into the bioreactor 13. The activated sludge may be introduced directly into the bioreactor 13 or upstream of the bioreactor 13.

The bioreactor 13 is configured to promote biological treatment of the wastewater. During filtration, the biological filter media 49 is actively circulated within the biological filtration chamber 47. The biological filter elements 51 are continuously moving within the bioreactor 13 (a so-called moving bed bioreactor). A fluid may be introduced into the biological filtration chamber 47 under pressure to circulate the biological filter media 49. The circulation of the biological filter media 49 is illustrated by in FIG. 1 by curved lines with the arrowheads indicating the flow direction. The fluid may be a liquid or a gas. In the present embodiment, pressurised air is introduced into the biological filtration chamber 47 to circulate the biological filter media 49 within the biological filtration chamber 47. The air pump 17 is configured to supply pressurised air to the at least one bioreactor air inlet 45. In a variant, a separate air pump may be provided to supply pressurised air to the bioreactor 13. The first control valve 19-1 is configured to control the supply of pressurised air to the at least one bioreactor air inlet 45. Alternatively, or in addition, a mechanical stirrer, for example comprising one or more rotating members, may be provided to circulate the biological filter media 49 within the biological filtration chamber 47. The use of a stirring mechanism may, for example, be appropriate if the bioreactor 13 is configured to support anaerobic microorganisms.

The bioreactor 13 comprises a biological filter media 49 comprising a plurality of biological filter elements 51. The filter media 49 typically occupy at least 30 percent (30%) of the filter chamber (by volume). The filter media 49 can occupy as much as 70 percent (70%) of the filter chamber (by volume). The filter media 49 in the present embodiment occupy approximately 50 percent (50%) of the filter chamber (by volume). The biological filter elements 51 support colonies of microorganisms (microbes) which break down waste. The influent enters the biological filtration chamber 47 for treatment. The biological filter elements 51 function as bio-carriers which support colonies of microorganisms (microbes). The microorganisms (microbes) typically form a biofilm over at least part of the surface of the biological filter elements 51. An aeration grid (not shown) may be provided to introduce air into the biological filtration chamber 47. The aeration grid may, for example, comprise one or more tubular member having a plurality of apertures through which the air is introduced into the biological filtration chamber 47. In use, the air pump 17 may supply pressurised air to the aeration grid. The aeration grid is typically disposed in a lower portion of the biological filtration chamber 47. The air causes the biological filter elements 51 to move within the biological filtration chamber 47 (forming a moving bed), thereby promoting contact with the waste. The introduction of air into the biological filtration chamber 47 also introduces oxygen into the biological filtration chamber 47 to promote aerobic activity. A screen (not shown) is provided over the bioreactor outlet 43 to retain the biological filter elements 51 in the biological filtration chamber 47.

The biological filter media 49 is preferably circulated continuously within the biological filtration chamber 47 during filtration. It has been recognised that the circulation of the biological filter elements 49 within the biological filtration chamber 47 may cause solid material to be dislodged from the biological filter elements 49. The circulation of the biological filter media 49 causes the biological filter elements 51 to contact each other and this may dislodge solid material from the surface of the biological filter elements 51 or from within the open cells of the biological filter elements 51. The solid material dislodged from the biological filter elements 51 may be in the form of flocs or a flocculent mass. The dislodged solid material may, for example, comprise flocs. The dislodged solid material may comprise or consist of solid particles having a diameter of less than or equal to ten (10) micrometres (i.e. ≤10 μm) and potentially less than or equal to five (5) micrometres (i.e. ≤5 μm). The solid particles dislodged from the biological filter elements 51 comprises solid particles which are held in suspension.

After biological filtration, the wastewater is discharged from the bioreactor 13 through the at least one bioreactor outlet 43 and introduced into the mechanical filter apparatus 15. The mechanical filter apparatus 15 is configured to perform mechanical filtration of the wastewater to remove at least some of the solid particles suspended in the wastewater discharged from the bioreactor 13. The mechanical filter apparatus 15 comprises a mechanical filter tank 60, at least one mechanical filter inlet 61, at least one mechanical filter outlet 63, at least one mechanical filter air inlet 65 and at least one mechanical filter waste outlet 67. The at least one mechanical filter inlet 61 is in fluid communication with the at least one bioreactor outlet 43. In use, the wastewater from the bioreactor 13 is introduced into the mechanical filter apparatus 15 through the at least one mechanical filter inlet 61. The at least one mechanical filter inlet 61 is disposed in a lower region of the mechanical filter apparatus 15; and the at least one mechanical filter outlet 63 is disposed in an upper region of the mechanical filter apparatus 15. This arrangement is appropriate for the mechanical filter apparatus 15 in the present embodiment in which an up-flow of wastewater is established. The relative position of the at least one mechanical filter inlet 61 and the at least one mechanical filter outlet 63 may be reversed if the mechanical filter apparatus 15 is configured to establish a down-flow of wastewater. The mechanical filter apparatus 15 performs mechanical filtration of the wastewater. In particular, the mechanical filter apparatus 15 comprises a mechanical filter chamber 70 containing a mechanical filter media 69 for performing mechanical filtration of the wastewater. The wastewater supplied to the mechanical filter apparatus 15 is filtered by the mechanical filter media 69 to remove at least some of the solid particles suspended in the wastewater supplied from the bioreactor 13. The treated wastewater is discharged from the mechanical filter apparatus 15 through the at least one mechanical filter outlet 63.

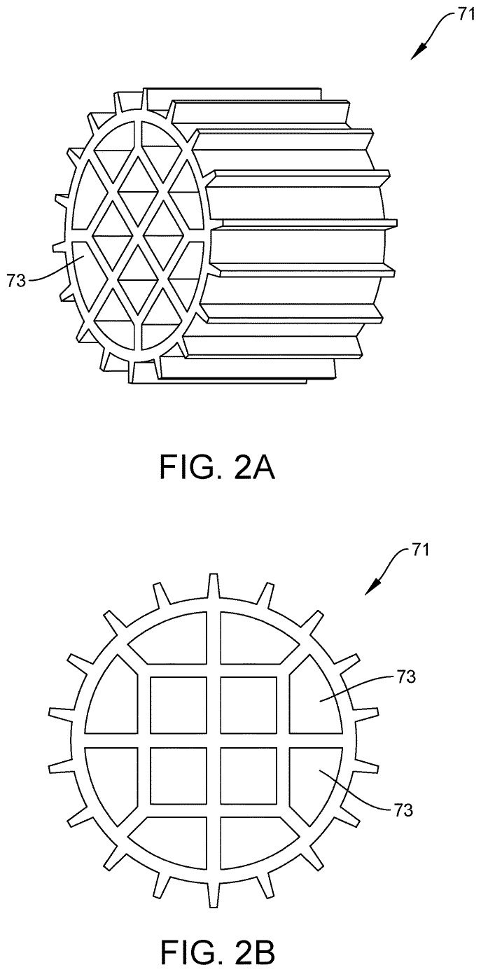

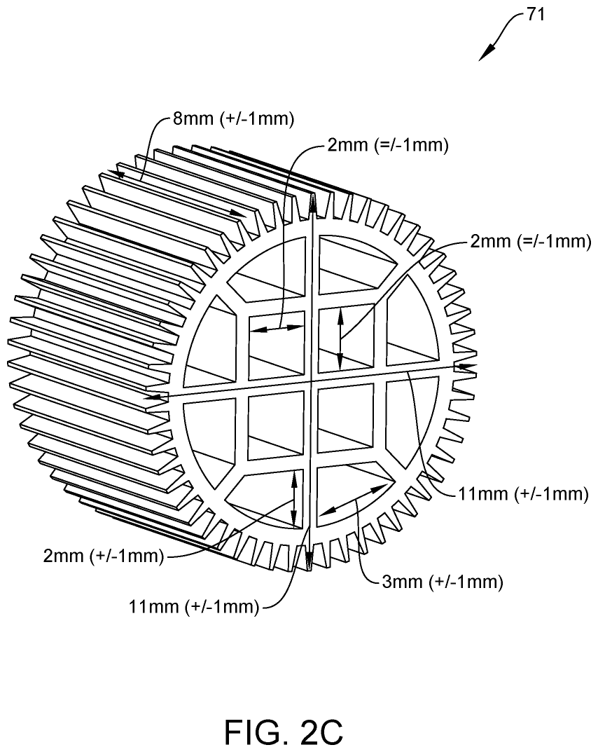

The mechanical filter media 69 comprises a plurality of mechanical filter elements 71. The mechanical filter elements 71 in the present embodiment comprise an open cell structure. A schematic representation of one of the mechanical filter elements 71 is shown in FIGS. 2A and 2B. A perspective view of a variant of one of the mechanical filter elements 71 is shown in FIG. 2C. The dimensions of the mechanical filter elements 71 are shown in FIG. 2C by way of example. The indicated dimensions have a tolerance of ±1 mm. The internal walls of the mechanical filter element 71 have a thickness of approximately 0.75 mm to 1 mm. A plurality of external ribs are formed around the outer perimeter of the mechanical filter elements 71. The ribs have a radial length of approximately 0.5 mm to 1 mm. It will be understood that the mechanical filter elements 71 having different dimensions may be used in the wastewater treatment plant 1 described herein. The mechanical filter elements 71 have a non-porous structure and each comprise one or more filter cells 73. The mechanical filter elements 71 comprise walls (internal and external) which form the one or more filter cells 73. The walls are impermeable and prevent the flow of liquid between adjacent filter cells 73. The one or more filter cells 73 each have a substantially uniform profile along the length of the mechanical filter elements 71. The one or more filter cells 73 are open at each end. In the present embodiment, the filter cells 73 each have a cross-sectional area in the range one (1) to five (5) square millimetres and a length greater than or equal to six (6) millimetres. A static filter pack 75 composed of the open cell filter media 69 is formed in the mechanical filter chamber 70. The mechanical filter elements 71 in the present embodiment have a positive buoyancy in water. The mechanical filter elements 71 float in the wastewater in the mechanical filter chamber 70 and form a static filter pack 75 in an upper region of the mechanical filter chamber 70. In a variant, the mechanical filter elements 71 may have a negative buoyancy and may form the static filter pack 75 in a lower region of the mechanical filter chamber 70. The mechanical filter elements 71 are effective in performing filtration by promoting settlement of the solid particles suspended in the wastewater. The solid particles settle within the filter cells 73 and on the surfaces of the mechanical filter elements 71. The mechanical filter elements 71 are formed by extrusion moulding a polymer in the present embodiment. Other techniques may be used to form the mechanical filter elements 71.

The mechanical filter apparatus 15 is periodically cleaned to discharge the solids accumulated in the mechanical filter chamber. The cleaning of the mechanical filter apparatus 15 comprises closing the at least one mechanical filter inlet 61 and the at least one mechanical filter outlet 63. The mechanical filter waste outlet 67 is closed during the cleaning operation and then opened to purge (or drain) the mechanical filter apparatus 15. In the present embodiment, a mechanical filter inlet valve 77 is provided for opening and closing the at least one mechanical filter inlet 61; and a mechanical filter outlet valve 79 is provided for opening and closing the at least one mechanical filter outlet 63. A mechanical filter waste valve 81 is provided for opening and closing the mechanical filter waste outlet 67. The mechanical filter inlet and outlet valves 77, 79 are both closed to close the mechanical filter inlet 61 and the mechanical filter outlet 63. The mechanical filter waste valve 81 is also closed to close the mechanical filter waste outlet 67.

The second control valve 19-2 is then opened to supply pressurised air into the mechanical filter chamber 70. The pressurised air is introduced into the mechanical filter chamber 70 and breaks up the static filter pack 75 and agitates the mechanical filter elements 71. The mechanical filter apparatus 15 may be open to atmosphere or a vent (not shown) may be opened. The accumulated waste is thereby dislodged from the mechanical filter elements 71. The supply of pressurised air continues for a predetermined period of time. The period of time may be determined through empirical analysis, for example. The mechanical filter waste valve 81 is then opened to open the mechanical filter waste outlet 67 and allow the wastewater in the mechanical filter chamber 70 to be discharged. The supply of pressurised air may optionally continue after the mechanical filter waste outlet 67 is opened. A portion of the wastewater discharged from the mechanical filter chamber 70 may be returned for further treatment within the wastewater treatment plant 1. In the present embodiment, a waste return line 83 is provided to return the wastewater discharged from the mechanical filter apparatus 15. A waste control valve 85 may optionally be provided to control the supply of wastewater to the waste return line 83. In the present embodiment, a portion of the waste accumulated in the mechanical filter chamber 70 is returned to the settlement tank 11 or the bioreactor 13. A portion of the waste may thereby be re-circulated through the wastewater treatment plant 1. A portion of the wastewater discharged from the mechanical filter chamber 70 may optionally be sent to waste or for further processing.

After the mechanical filter chamber 70 has been drained, the mechanical filter waste valve 81 is closed to close the mechanical filter waste outlet 67. The supply of pressurised air to the mechanical filter chamber 70 is stopped by closing the second control valve 19-2. The at least one mechanical filter inlet 61 and the at least one mechanical filter outlet 63 are then opened to re-establish the flow of wastewater through the mechanical filter apparatus 15.

In use, the mechanical filter elements 71 form a static filter pack 75 which is operative to filter solids from the wastewater. The mechanical filter elements 71 may have positive, negative or neutral buoyancy. The mechanical filter elements 71 have an open cell structure which provides a high retention capacity. The flow rate per unit cross sectional area of the static filter pack 75 may be less than 20 m3/m2/h exclusive, for example in the range 0.1 m3/m2/h to 19.9 m3/m2/h; 5 m3/m2/h to 19.5 m3/m2/h; or 11 m3/m2/h to 19 m3/m2/h. It has been recognised that these flow rates per unit cross-sectional area are particularly effective in the removal of flocs (also known as flocculant masses) from the wastewater. The flocs comprise or consist of loosely aggregated particles or soft flakes. At least in certain embodiments, the flocs can settle within the filter cells 73 of the mechanical filter elements 71 or on an exterior thereof. The relatively low flow rate through the static filter pack 75 helps to reduce or avoid disrupting the flocs. A higher flow rate could potentially cause certain types of flocs to break down or disintegrate into smaller flocs or individual particles. At least in certain embodiments, the wastewater treatment plant 1 is capable of capturing very fine particles suspended in the wastewater. The treated water from the mechanical filter apparatus 15 may be discharged from the wastewater treatment plant 1 or sent to a receiving watercourse. Alternatively, the treated water may be sent for further treatment downstream.

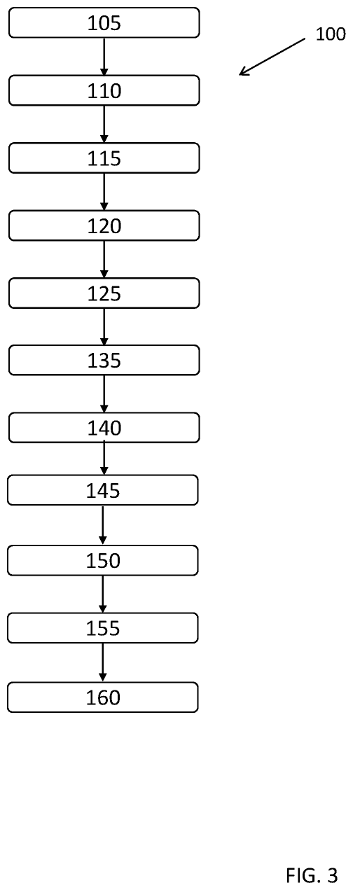

The operation of the wastewater treatment plant 1 to treat wastewater is illustrated in a first flow diagram 100 shown in FIG. 3. The wastewater to be treated is received as influent wastewater in the wastewater treatment plant 1 (BLOCK 105). The wastewater is optionally introduced into the settlement tank 11 to promote settlement of solids (BLOCK 110). The wastewater is discharged from the settlement tank 11 into the bioreactor 13 (BLOCK 115). The bioreactor 13 performs biological filtration of the wastewater and the biologically filtered water is discharged from the bioreactor (BLOCK 120). The movement of the biological filter elements causes solid particles, which may comprise or consist of flocs, to be introduced into suspension in the wastewater discharged from the bioreactor 13. The wastewater is supplied from the bioreactor 13 to the mechanical filter apparatus 15 (BLOCK 125). The wastewater discharged from the bioreactor 13 typically comprises particles which are suspended in the wastewater. The particles may group together to form flocs which are suspended in the wastewater. The flocs may be formed of loosely aggregated particles. The mechanical filter apparatus 15 mechanically filters the wastewater to remove at least some of the solid particles held in suspension (BLOCK 130). The treated wastewater (effluent) is discharged from the mechanical filter apparatus 15 (BLOCK 135). The mechanical filter apparatus 15 is periodically cleaned (BLOCK 140). The cleaning comprises breaking up the static filter pack 75, for example by introducing a fluid, such as air, to disrupt the static filter pack 75 (BLOCK 145). The accumulated solid waste is dislodged form the static filter pack and discharged from the mechanical filter apparatus 15 (BLOCK 150). At least some of the solid waste from the mechanical filter apparatus 15 is returned through the waste return line 83 and passes through the bioreactor 13 again (BLOCK 155). The process continues (BLOCK 160).

The wastewater treatment plant 1 in the above embodiment has been described with reference to one each of the primary settlement tank 11, the bioreactor 13 and the mechanical filter apparatus 15. This is merely illustrative and the wastewater treatment plant 1 may comprise more than one of each of the primary settlement tank 11, the bioreactor 13 and the mechanical filter apparatus 15. For example, one or more of the bioreactors 13 may be provided. A plurality of the bioreactors 13 may be provided connected in parallel or in series. One or more primary settlement tank 11 may be provided upstream of the one or more bioreactor 13. A plurality of the primary settlement tanks 11 may be connected in parallel or in series upstream of the bioreactor(s) 13. One or more tertiary settlement tank 20 may be provided downstream of the one or more bioreactor 13. A plurality of the tertiary settlement tanks 20 may be connected in parallel or in series downstream of the bioreactor(s) 13. A pump (not shown) may be provided for pumping accumulated waste from the wastewater treatment plant 1, for example from the primary settlement tank 11 and/or the tertiary settlement tank 20.

The wastewater treatment plant 1 in the above embodiment is described with reference to a bioreactor 13 comprising a moving bed bioreactor (MBBR). Other types of bioreactor 13 are contemplated for the wastewater treatment plant 1. The bioreactor 13 may be configured to perform aerobic, anaerobic or anoxic biological filtration of the wastewater. Aerobic biological filtration is performed by microorganisms (microbes) which require oxygen. Anaerobic biological filtration is performed by microorganisms (microbes) which require little or no oxygen (<0.5 mg/l or <0.2 mg/l). Anoxic biological filtration is performed by microorganisms (microbes) that release bound oxygen (nitrite/nitrate etc.), thereby reducing or obviating the need to introduce air to aerate the wastewater.

As outlined above, a proportion of the accumulated waste may be re-introduced into the bioreactor 13 in the form of an activated sludge. The activated sludge has a high concentration of microorganisms, including bacteria, protozoa and fungi, which are present as loose-clumped mass of fine particles. The clumps may be kept in suspension by stirring (anaerobic systems) or with air (aerobic systems), with the aim of removing organic matter from wastewater. This process is typically referred to as Return Activated Sludge (RAS).

The bioreactor 13 may comprise an Integrated Fixed Film Activated Sludge (IFAS). This process is similar to the moving bed bioreactor MBBR described herein. An activated sludge, for example accumulated in the tertiary settlement tank, is introduced into a filter chamber comprising the filter media. The filter media and activated sludge may both be present in the same filter chamber. The filter chamber may comprise an anoxic zone and an aerobic zone. The activated sludge may be introduced into the anoxic zone; and a moving bed bioreactor may be established in the aerobic zone, for example by introducing air to agitate the filter media.

The bioreactor 13 may comprise a Sequencing Batch Reactor (SBR) which uses both aerobic and anaerobic processes in timed sequences. The SBR can undertake both nitrification and denitrification. A stable and constant influent volume is supplied to the filter chamber. The filter chamber is aerated to promote aerobic reaction. The supply of air is then stopped to promote settlement. The water in the filter chamber is then decanted as effluent. The waste remaining in the filter chamber is then discharged to waste. This process may be used with a chemical flocculant to remove phosphates. Additional biological treatment may be performed on the wastewater discharged from the filter tank.

The bioreactor 13 may comprise a Membrane Bioreactor (MBR). The MBR combines a biological treatment process with membrane filtration. In the MBR system, organic matter in the wastewater is broken down by microorganisms. The treated water is then passed through a membrane filter to remove any remaining suspended solids and microorganisms. This results in a highly treated effluent that is suitable for reuse or discharge to the environment.

The bioreactor 13 may comprise a submerged aerated filter (SAF). The biological filter elements may be held in a static bed submerged in the wastewater. The biological filter elements are aerated to promote aerobic biological filtration.

Other types of mechanical and/or biological filtration may be performed on the wastewater. For example, the wastewater may be filtered using: (i) Dissolved Air Flotation (DAF) which brings particles to the surface of the water to facilitate removal, for example by a weir; or (ii) lamella separators in the form of angled plates which slow the flow of liquid and promote settlement of particles for collection and removal by a sludge pump.

A mechanical filter apparatus 15 of the type described herein 1 may be provided upstream of the bioreactor 13. For example, the mechanical filter apparatus 15 may be provided between the primary settlement tank 11 and the bioreactor 13.

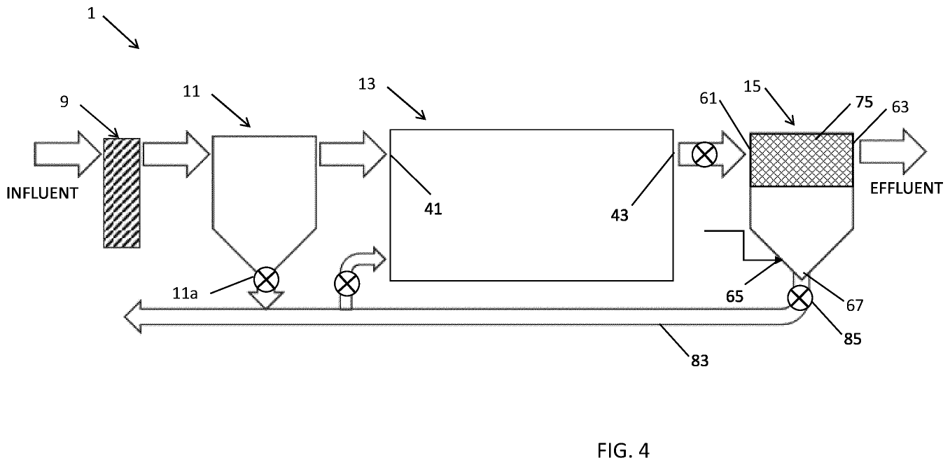

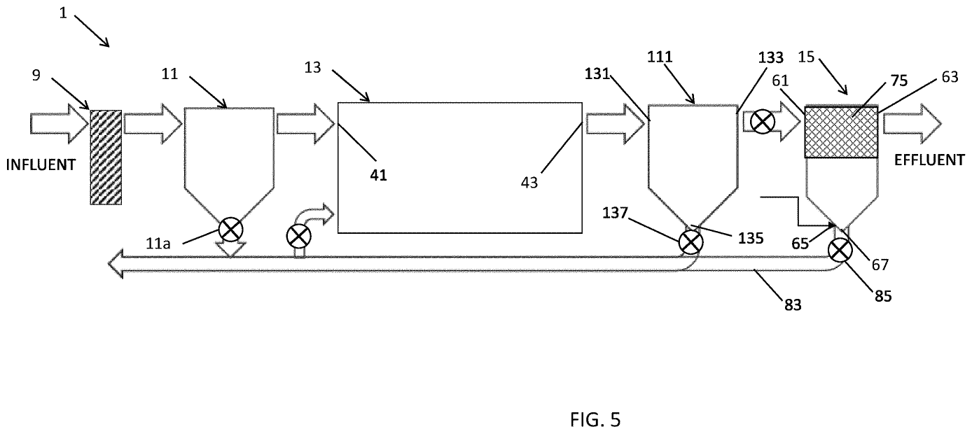

A variant of the wastewater treatment plant 1 according to the above embodiment will now be described with reference to FIG. 4. Like reference numerals are used for like components. The description focuses on the differences between the wastewater treatment plant 1 according to the present embodiment and the embodiment described with reference to FIG. 1.

The wastewater treatment plant 1 comprises a primary settlement tank 11, a bioreactor 13 and a mechanical filter apparatus 15. The wastewater treatment plant 1 may optionally comprise a tertiary settlement tank 20. The tertiary settlement tank 20 may be disposed between the bioreactor 13 and the mechanical filter apparatus 15. The wastewater treatment plant 1 also comprises a primary screen 9 disposed upstream of the primary settlement tank 11. The primary screen 9 is configured to filter relatively large debris and detritus from the influent supplied to the wastewater treatment plant 1. The primary screen 9 comprises a plurality of apertures through which the wastewater is passed to remove debris. The primary screen 9 may comprise a sieve, a mesh or a membrane, for example. The wastewater is introduced into the primary settlement tank 11 after being filtered by the primary screen 9. At least some of the debris which passes through the primary screen 9 settles out of suspension in the primary settlement tank 11. The waste accumulated in the primary settlement tank 11 is discharged to waste through a primary settlement tank waste outlet 11a. A valve (represented by a valve symbol) may be provided on the primary settlement tank waste outlet 11a.

The bioreactor 13 may comprise a moving bed bioreactor (MBBR) of the type described herein. In the present embodiment, the bioreactor 13 comprises a static bed bioreactor 13. The bioreactor 13 may, for example, comprise a submerged aerated filter (SAF). The biological filter elements 51 form a bed which is continuously aerated. The biological filter elements 51 are at least substantially static in the bed. The biological filter elements 51 may be held in place by one or more screens. The submerged aerated filter may comprise an integrated settlement tank, for example in the form of a settlement chamber formed before an outlet of the submerged aerated filter. In a variant, the bioreactor 13 may not contain a biological filter media. For example, activated sludge from downstream of the bioreactor 13 may be re-introduced into the bioreactor 13. The activated sludge may be introduced directly into the bioreactor 13 or upstream of the bioreactor 13. Other types of bioreactor 13 are contemplated.

The mechanical filter apparatus 15 is configured to perform mechanical filtration of the wastewater to remove at least some of the solid particles suspended in the wastewater discharged from the bioreactor 13. The mechanical filter apparatus 15 comprises a mechanical filter tank 60, at least one mechanical filter inlet 61, at least one mechanical filter outlet 63, at least one mechanical filter air inlet 65 and at least one mechanical filter waste outlet 67. The at least one mechanical filter inlet 61 is in fluid communication with the at least one bioreactor outlet 43. In use, the wastewater from the bioreactor 13 is introduced into the mechanical filter apparatus 15 through the at least one mechanical filter inlet 61. The at least one mechanical filter inlet 61 is preferably disposed in a lower region of the mechanical filter apparatus 15; and the at least one mechanical filter outlet 63 is preferably disposed in an upper region of the mechanical filter apparatus 15. The mechanical filter apparatus 15 filters the wastewater supplied from the bioreactor 13. The mechanical filter chamber 70 contains a mechanical filter media 69 for performing mechanical filtration of the wastewater. The mechanical filter media 69 comprises a plurality of the mechanical filter elements 71 of the type described herein. The mechanical filter elements 71 form a static filter pack 75 suitable for filtering particles and matter suspended in the water as it flows through the mechanical filter apparatus 15. The mechanical filter elements 71 have an open cell structure to promote settlement of suspended particles in the static filter pack 75. The mechanical filter elements 71 each have one or more filter cell 73. The wastewater is filtered by the mechanical filter media 69 to remove at least some of the solid particles suspended in the wastewater supplied from the bioreactor 13. The treated wastewater (effluent) is discharged from the mechanical filter apparatus 15 through the at least one mechanical filter outlet 63.

The mechanical filter apparatus 15 is periodically cleaned to discharge the solids accumulated in the mechanical filter chamber 70. The cleaning of the mechanical filter apparatus 15 may comprise closing the at least one mechanical filter inlet 61 and/or the at least one mechanical filter outlet 63. The mechanical filter waste outlet 67 is closed during the filtering operation; and opened during the cleaning operation to purge (or drain) the mechanical filter tank 60. An air supply conduit is provided for supplying air to the air inlet 65 into the mechanical filter chamber 70. The air introduced into the mechanical filter chamber 70 agitates the mechanical filter elements 71, disrupting the static filter pack. By agitating the mechanical filter elements 71, waste and debris accumulated in the one or more filter cells 73 formed in the mechanical filter elements 71 is dislodged. The dislodged waste may be expelled to waste through the mechanical filter waste outlet 67. Air may be pumped into the mechanical filter tank 60 by an air pump (not shown) to agitate the mechanical filter elements 71 during the cleaning operation. Alternatively, or in addition, air may be drawn into the mechanical filter chamber 70 through the air supply conduit. A one-way valve may be provided on the air supply conduit. When the mechanical filter waste outlet 67 is opened, the water in the mechanical filter chamber 70 may be drained resulting in a decrease in the pressure in the mechanical filter chamber 70 to below atmospheric pressure. The reduced pressure may cause air to be drawn into the mechanical filter chamber 70 through the air supply conduit. The air is drawn into a lower portion of the mechanical filter chamber 70 and agitates the mechanical filter elements 71 as the mechanical filter tank 60 is drained. Other techniques may be employed to clean the mechanical filter apparatus 15. For example, the mechanical filter elements 71 may be backwashed to dislodge trapped debris. A backwashing liquid, such as water, may be introduced into the mechanical filter chamber 70 to clean the mechanical filter elements 71. The backwashing liquid may be discharged to waste. Alternatively, at least some of the backwashing liquid may be returned to the wastewater treatment plant 1 for further treatment. For example, the backwashing liquid may be introduced into the bioreactor 13. The same cleaning process(es) may be used to clean the mechanical filter apparatus 15 in each of the embodiments of the wastewater treatment plant 1 described herein.

A portion of the wastewater discharged from the mechanical filter chamber 70 may be returned for further treatment within the wastewater treatment plant 1. In the present embodiment, a waste return line 83 is provided to return the wastewater discharged from the mechanical filter apparatus 15. A waste control valve 85 may optionally be provided to control the supply of waste to the waste return line 83. In the present embodiment, a portion of the waste from the mechanical filter chamber 70 is returned to the bioreactor 13. The waste returned from the mechanical filter apparatus 15 is typically in the form of a sludge (comprising or consisting of precipitated solid matter). The waste may be introduced into the bioreactor 13 through the bioreactor inlet 41 or a separate inlet. At least some of the waste is thereby re-circulated through the bioreactor 13 and the mechanical filter apparatus 15. A portion of the waste discharged from the mechanical filter chamber 70 may be sent to waste or for further treatment downstream of the wastewater treatment plant 1.

In use, the mechanical filter elements 71 form a static filter pack 75 which is operative to filter solids from the wastewater. The mechanical filter elements 71 may have positive, negative or neutral buoyancy. The mechanical filter elements 71 have an open cell structure which provides a high retention capacity. The flow rate per unit cross sectional area of the static filter pack 75 may be less than 20 m3/m2/h exclusive, for example in the range 0.1 m3/m2/h to 19.9 m3/m2/h; 5 m3/m2/h to 19.5 m3/m2/h; or 11 m3/m2/h to 19 m3/m2/h. It has been recognised that these flow rates per unit cross-sectional area are particularly effective in the removal of flocs (also known as flocculant masses) from the wastewater. The flocs comprise or consist of loosely aggregated particles or soft flakes. At least in certain embodiments, the flocs can settle within the filter cells 73 of the mechanical filter elements 71 or on an exterior thereof. The relatively low flow rate through the static filter pack 75 helps to reduce or avoid disrupting the flocs. A higher flow rate could potentially cause certain types of flocs to break down or disintegrate into smaller flocs or individual particles. At least in certain embodiments, the wastewater treatment plant 1 is capable of capturing very fine particles suspended in the wastewater. The treated water from the mechanical filter apparatus 15 may be discharged from the wastewater treatment plant 1 or sent to a receiving watercourse. Alternatively, the treated water may be sent for further treatment downstream.

A further variant of the wastewater treatment plant 1 according to the embodiment shown in FIG. 4 will now be described with reference to FIG. 5. Like reference numerals are used for like components. The description focuses on the differences between the wastewater treatment plant 1 according to the present embodiment and the embodiment described with reference to FIG. 4.

The bioreactor 13 may be a moving bed bioreactor or a static bed bioreactor. For example, the bioreactor 13 may comprise a submerged aerated filter (SAF). In the present embodiment, the bioreactor 13 does not include biological filter elements. The bioreactor 13 may be an activated sludge bioreactor. Other types of bioreactor 13 are contemplated.

The wastewater treatment plant 1 in this embodiment comprises at least one tertiary settlement tank 111. The tertiary settlement tank 111 is disposed downstream of the bioreactor 13 and upstream of the mechanical filter apparatus 15. The tertiary settlement tank 111 comprises at least one tertiary settlement tank inlet 131 which is in fluid communication with the at least one bioreactor outlet 43. In use, the wastewater from the bioreactor 13 is introduced into the tertiary settlement tank 111. The tertiary settlement tank 111 comprises at least one tertiary settlement tank outlet 133 and at least one tertiary settlement tank waste outlet 135. As shown in FIG. 5, the at least one tertiary settlement tank inlet 131 and the at least one tertiary settlement tank outlet 133 are disposed in an upper region of the tertiary settlement tank 111. The at least one tertiary settlement tank waste outlet 135 is disposed in a lower region of the tertiary settlement tank 111. In use, water treated by the bioreactor 13 is introduced into the tertiary settlement tank 111 through the at least one tertiary settlement tank inlet 131. Solid material precipitates from the wastewater and sinks to the bottom of the tertiary settlement tank 111. The wastewater is discharged from the tertiary settlement tank 111 through the at least one tertiary settlement tank outlet 133 to the mechanical filter apparatus 15. At least one settlement tank waste valve 137 is provided for controlling the discharge of solids and waste through the tertiary settlement tank waste outlet 35. The waste discharged from the at least one settlement tank 11 is typically in the form of a sludge. The at least one settlement tank waste valve 37 is selectively opened to expel accumulated waste. The waste expelled from the at least one tertiary settlement tank 111 may be sent to waste or for further treatment. A proportion of the waste expelled from the at least one tertiary settlement tank 111 may be returned to the bioreactor 13 for treatment. A wastewater control valve (not shown) may optionally be provided to control the discharge of wastewater from the tertiary settlement tank 111 through the at least one settlement tank outlet 33.

In use, the mechanical filter elements 71 form a static filter pack 75 which is operative to filter solids from the wastewater. The mechanical filter elements 71 may have positive, negative or neutral buoyancy. The mechanical filter elements 71 have an open cell structure which provides a high retention capacity. The flow rate per unit cross sectional area of the static filter pack 75 may be less than 20 m3/m2/h exclusive, for example in the range 0.1 m3/m2/h to 19.9 m3/m2/h; 5 m3/m2/h to 19.5 m3/m2/h; or 11 m3/m2/h to 19 m3/m2/h. It has been recognised that these flow rates per unit cross-sectional area are particularly effective in the removal of flocs (also known as flocculant masses) from the wastewater. The flocs comprise or consist of loosely aggregated particles or soft flakes. At least in certain embodiments, the flocs can settle within the filter cells 73 of the mechanical filter elements 71 or on an exterior thereof. The relatively low flow rate through the static filter pack 75 helps to reduce or avoid disrupting the flocs. A higher flow rate could potentially cause certain types of flocs to break down or disintegrate into smaller flocs or individual particles. At least in certain embodiments, the wastewater treatment plant 1 is capable of capturing very fine particles suspended in the wastewater. The treated water from the mechanical filter apparatus 15 may be discharged from the wastewater treatment plant 1 or sent to a receiving watercourse. Alternatively, the treated water may be sent for further treatment downstream.

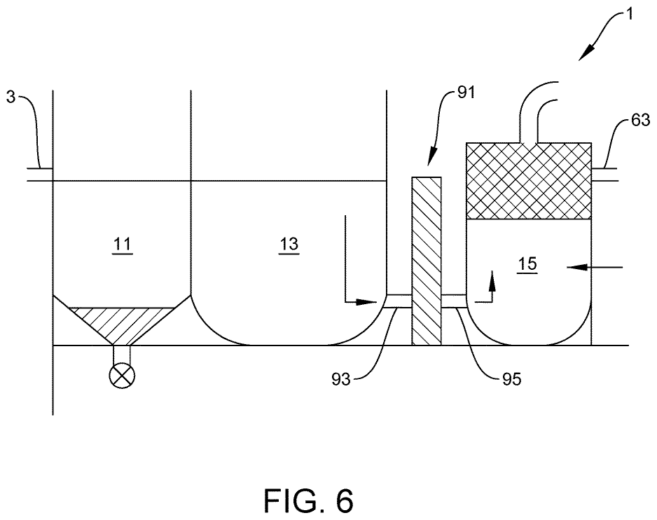

A further embodiment of the wastewater treatment plant 1 will now be described with reference to FIG. 6. Like reference numerals are used for like features in this embodiment. The description herein focuses on the differences between the present embodiment of the wastewater treatment plant 1 and the previous embodiment described herein.

The wastewater treatment plant 1 in the present embodiment comprises an electrocoagulation unit 91. The electrocoagulation unit 91 uses electrochemical process to remove suspended, emulsified, or dissolved pollutants from the wastewater. The electrocoagulation unit 91 supplies an electric current to the wastewater to agglomerate matter suspended in the wastewater. The electrocoagulation unit 91 performs an electro-chemical process that can remove suspended, emulsified or dissolved contaminants from the wastewater using an electric flow of charge. The electrocoagulation unit 91 generates a direct flow of charge into the wastewater to free the metal ions from sacrificial anodes that will cause contaminants to be agglomerated for capture within the mechanical filter apparatus 15. The electrocoagulation unit 91 may comprise one or more sacrificial electrodes (not shown) to support the electrochemical process. The electrocoagulation unit 91 is operative to agglomerate matter suspended in the wastewater. The particles suspended in the wastewater may agglomerate or aggregate to form flocs (also known as flocculant masses). The resulting flocs comprise or consist of loosely aggregated particles or soft flakes. The electrocoagulation unit 91 is located downstream of the bioreactor 13. The electrocoagulation unit 91 is located upstream of the mechanical filter apparatus 15. As shown in FIG. 3, the electrocoagulation unit 91 is disposed between the bioreactor 13 and the mechanical filter apparatus 15. The electrocoagulation unit 91 comprises an electrocoagulation unit inlet 93 and an electrocoagulation unit outlet 95. The electrocoagulation unit inlet 93 is connected to the at least one bioreactor outlet 43 of the bioreactor 13. The wastewater filtered by the bioreactor 13 is supplied to the electrocoagulation unit 91. The electrocoagulation unit outlet 95 is connected to the at least one mechanical filter inlet 61. The wastewater treated by the electrocoagulation unit 91 is supplied to the mechanical filter apparatus 15. In use, the electrocoagulation unit 91 is operative to agglomerate the solid waste dislodged from the biological filter elements in the bioreactor 13. The agglomerated matter from the electrocoagulation unit 91 is suspended in the wastewater which is introduced to the mechanical filter apparatus 15 disposed downstream thereof. The mechanical filter apparatus 15 of the type described herein is effective in mechanically filtering the wastewater from the electrocoagulation unit 91.

In use, the electrocoagulation unit 91 may be operative to remove phosphates from the wastewater. The electrocoagulation unit 91 may cause the phosphates to come out of solution (i.e. to precipitate) as solid particles in the wastewater. The electrocoagulation unit 91 may cause other compounds to come out of solution (i.e. to precipitate) as solid particles in the wastewater. The solid particles could be removed using ultra-filtration or reverse osmosis, for example. However, it has been determined that the mechanical filter apparatus 15 described herein is effective also in filtering the solid particles resulting from the operation of the electrocoagulation unit 91. The mechanical filter apparatus 15 is provided downstream of the electrocoagulation unit 91 to remove at least some of the solid particles through mechanical filtration. The combination of the electrocoagulation unit 91 and the mechanical filter apparatus 15 is believed to be patentable independently. This combination has particular application in a wastewater treatment process. However, other applications are also contemplated.

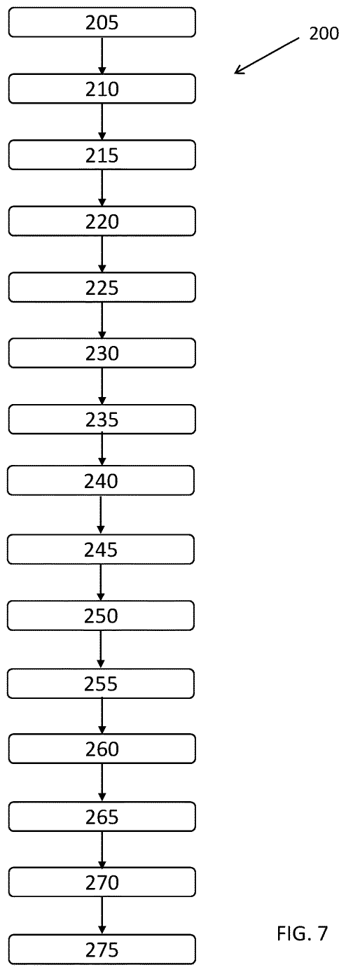

The operation of the wastewater treatment plant 1 to treat wastewater is illustrated in a second flow diagram 200 shown in FIG. 7. The wastewater to be treated is received as influent wastewater in the wastewater treatment plant 1 (BLOCK 205). The wastewater is optionally introduced into the settlement tank 11 to promote settlement of solids (BLOCK 210). The wastewater is discharged from the settlement tank 11 into the bioreactor 13 (BLOCK 215). The bioreactor 13 performs biological filtration of the wastewater and the biologically filtered water is discharged from the bioreactor (BLOCK 220). The movement of the biological filter elements causes solid particles, which may comprise or consist of flocs, to be introduced into suspension in the wastewater discharged from the bioreactor 13. The wastewater is supplied from the bioreactor 13 to the electrocoagulation unit 91 (BLOCK 225). The electrocoagulation unit 91 is operative to agglomerate the solid particles held in suspension (BLOCK 230). Alternatively, or in addition, the electrocoagulation unit 91 may cause phosphate dissolved in the wastewater to come out of solution and form particles. The phosphate particles may then agglomerate and the resulting agglomerated particles may be suspended in the wastewater. The treated wastewater is discharged from the electrocoagulation unit 91 (BLOCK 235). The wastewater is supplied from the electrocoagulation unit 91 to the mechanical filter apparatus 15 (BLOCK 240). The mechanical filter apparatus 15 mechanically filters the wastewater to remove at least some of the solid particles held in suspension (BLOCK 245). The treated wastewater (effluent) is discharged from the mechanical filter apparatus 15 (BLOCK 250). The mechanical filter apparatus 15 is periodically cleaned (BLOCK 255). The cleaning comprises breaking up the static filter pack 75, for example by introducing a pressurised fluid, such as air (BLOCK 260). The accumulated solid waste is dislodged form the static filter pack and discharged from the mechanical filter apparatus 15 (BLOCK 265). At least some of the solid waste from the mechanical filter apparatus 15 is returned through the waste return line 83 and passes through the bioreactor 13 again (BLOCK 270). The process continues (BLOCK 275).

The wastewater treatment plant 1 has been described with reference to an electrocoagulation unit 91. Alternatively, or in addition, the wastewater treatment plant 1 may comprise at least one chemical dosing system 97 for introducing a (chemical) coagulating agent into the wastewater. The chemical dosing system 97 may be disposed between the bioreactor 13 and the mechanical filter apparatus 15. The chemical dosing system 97 is configured to introduce a dose of the coagulating agent into the wastewater. The coagulating agent may be introduced into the wastewater continuously or intermittently. The coagulating agent is positively charged and neutralizes the solid particles suspended in the wastewater stream. In use, the coagulating agent promotes coagulation or agglomeration of the particles suspended in the wastewater. The coagulating agent may also cause dissolved compounds, such as phosphates, to come out of solution to form particles. The agglomerated particles may form flocs (also known as flocculant masses) comprising or consisting of loosely aggregated particles or soft flakes. At least some of the flocs are suspended in the wastewater. The coagulating agent in the present embodiment is a chemical, such as Ferric Chloride or Poly Aluminium Sulphate PAC. The coagulating agent may cause phosphate dissolved in the wastewater to come out of solution and form particles. The particles come out of solution and are agglomerated. The chemical dosing system 97 may replace the electrocoagulation unit 91. In this arrangement, the chemical dosing system 97 is located downstream of the bioreactor 13 and upstream of the mechanical filter apparatus 15. The chemical dosing system 97 is disposed between the bioreactor 13 and the mechanical filter apparatus 15. The chemical dosing system 97 is configured to supply the coagulating agent to the wastewater discharged from the bioreactor 13. Chemical floc formation (detention time) is a function of the volume of wastewater being dosed but a detention time of 10 to 40 minutes is appropriate. The water is agitated to spread the coagulating agent. The mixed water is stabilized, and at least some of the particles form together or agglomerate whereupon they drop out of suspension (flocculation) for collection.

The coagulating agent may comprise or consist of an organic or inorganic chemical or a polymer base. Suitable coagulating agents include ferric sulphate, ferric chloride, ferrous sulphate, aluminium sulphate and aluminium chloride or polyaluminium chloride (PAM), activated silica, bentonite, and metallic hydroxides with a polymeric structure), natural flocculants (e.g., starch derivatives, Moringa oleifera polysaccharides, and alginates, or seaweed), and synthetic flocculants (e.g., polyacrylamides, polyethylene-imines, polyamines, polydiallyldimethylammonium chloride (Poly DADMACs) and polytannate, polyamides-amines, polyamines, and polyethylene-oxide). The chemical dosing system 97 may be configured to introduce one or more of these coagulating agents into the wastewater.

The wastewater is supplied from the bioreactor 13 to the chemical dosing system 97. The coagulating agent is introduced into the waste water and causes agglomeration of the solid particles held in suspension. At least in certain embodiments, the coagulating agent may cause phosphate dissolved in the wastewater to come out of solution and form particles. The phosphate particles may agglomerate to form flocs which are suspended in the wastewater. The treated wastewater is discharged to the mechanical filter apparatus 15. The mechanical filter apparatus 15 mechanically filters the wastewater to remove at least some of the solid particles and/or flocs held in suspension. The treated wastewater (effluent) is discharged from the mechanical filter apparatus 15.

In use, the static filter pack 75 formed by the mechanical filter elements 71 is effective in filtering the flocs suspended in the wastewater. The mechanical filter elements 71 have an open cell structure which provides a high retention capacity. At least in certain embodiments, the flow rate per unit cross sectional area of the static filter pack 75 may be less than 20 m3/m2/h exclusive, for example in the range 0.1 m3/m2/h to 19.9 m3/m2/h; 5 m3/m2/h to 19.5 m3/m2/h; or 11 m3/m2/h to 19 m3/m2/h. It has been recognised that these flow rates per unit cross-sectional area are particularly effective in the removal of the flocs from the wastewater. The flocs can settle within the filter cells 73 of the mechanical filter elements 71 or on an exterior thereof. The relatively low flow rate through the static filter pack 75 helps to reduce or avoid disrupting the flocs. A higher flow rate could potentially cause certain types of flocs to break down or disintegrate into smaller flocs or individual particles.

The process of coagulation and flocculation creates particles that then need to be captured. The mechanical filter apparatus 15 described herein can do this effectively. At least in certain embodiments, this can be performed without the need to utilise settlement tanks and/or without requiring large volumes of water to backwash or clean a filter screen. The open cell structure of the mechanical filter elements 71 is suitable for retaining softer flocs within the filter cells. The mechanical filer elements 71 have a high retention capacity for accumulating waste without forming a barrier (floc buildup) that the water would then be unable to penetrate.

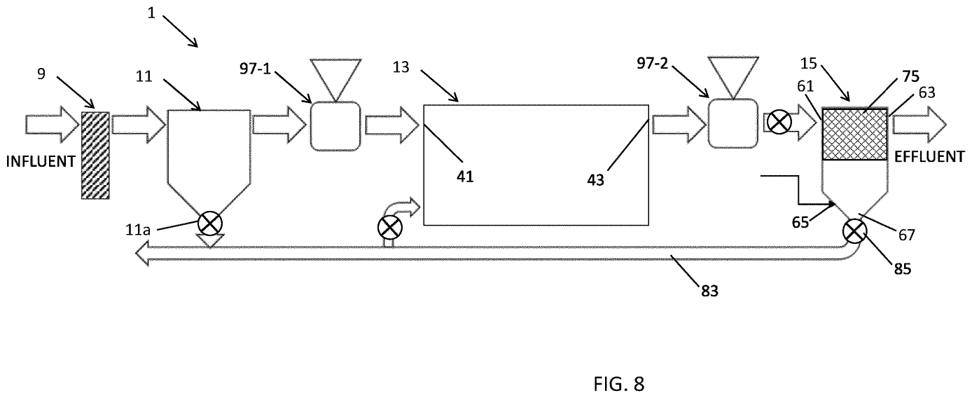

A variant of the wastewater treatment plant 1 shown in FIG. 6 will now be described with reference to FIG. 8. Like reference numerals are used for like components. The description focuses on the differences between the wastewater treatment plant 1 according to the present embodiment and the embodiment described with reference to FIG. 8.

The wastewater treatment plant 1 comprises a primary screen 9, a primary settlement tank 11, a bioreactor 13 and a mechanical filter apparatus 15. The wastewater treatment plant 1 may optionally comprise a tertiary settlement tank 20. The tertiary settlement tank 20 may be disposed between the bioreactor 13 and the mechanical filter apparatus 15. The bioreactor 13 comprises a moving bed bioreactor (MBBR) in the present embodiment. Other types of bioreactor 13 are contemplated. It will be understood that one or more of the primary settlement tank 11, the bioreactor 13 and the mechanical filter apparatus 15 may comprise a civil installation, for example in the form of a concrete tank, a steel tank or glass fibre reinforced polymer (GFRP) tank.

The wastewater treatment plant 1 in the present embodiment comprises a first chemical dosing system 97-1 and a second chemical dosing system 97-2. The first chemical dosing system 97-1 is disposed upstream of the bioreactor 13; and the second chemical dosing system 97-2 is disposed downstream of the bioreactor 13. In the present embodiment, the first chemical dosing system 97-1 is disposed between the primary settlement tank 11 and the bioreactor 13; and the second chemical dosing system 97-2 is disposed between the bioreactor 13 and the mechanical filter apparatus 15. The first and second chemical dosing systems 97-1, 97-2 are configured to introduce a coagulating agent into the wastewater. The coagulating agent may cause one or more dissolved compounds, such as phosphate, to come out of solution and form particles. Alternatively, or in addition, clumps of the microorganisms on the biological filter elements may be dislodged, thereby introducing more particles in the wastewater. The coagulating agent promotes coagulation or agglomeration of the particles suspended in the wastewater. The coagulating agent may promote coagulation of particles in the wastewater, for example to form flocs. The wastewater treatment plant 1 may be modified to replace at least one of the first and second chemical dosing systems 97-1, 97-2 with one or more electrocoagulation unit 91 of the type described herein.

The mechanical filter apparatus 15 is configured to perform mechanical filtration of the wastewater to remove at least some of the solid particles suspended in the wastewater discharged from the bioreactor 13. The mechanical filter apparatus 15 comprises a mechanical filter tank 60, at least one mechanical filter inlet 61, at least one mechanical filter outlet 63, at least one mechanical filter air inlet 65 and at least one mechanical filter waste outlet 67. The at least one mechanical filter inlet 61 is in fluid communication with the at least one bioreactor outlet 43. In use, the wastewater from the bioreactor 13 is introduced into the mechanical filter apparatus 15 through the at least one mechanical filter inlet 61. The at least one mechanical filter inlet 61 is preferably disposed in a lower region of the mechanical filter apparatus 15; and the at least one mechanical filter outlet 63 is preferably disposed in an upper region of the mechanical filter apparatus 15. The mechanical filter apparatus 15 filters the wastewater supplied from the bioreactor 13. The mechanical filter chamber 70 contains a mechanical filter media 69 for performing mechanical filtration of the wastewater. The mechanical filter media 69 comprises a plurality of the mechanical filter elements 71 of the type described herein. The mechanical filter elements 71 form a static filter pack 75 suitable for filtering particles and matter suspended in the water as it flows through the mechanical filter apparatus 15. The mechanical filter elements 71 have an open cell structure to promote settlement of suspended particles in the static filter pack 75. The mechanical filter elements 71 each have one or more filter cell 73. The wastewater is filtered by the mechanical filter media 69 to remove at least some of the solid particles suspended in the wastewater supplied from the bioreactor 13. The treated wastewater (effluent) is discharged from the mechanical filter apparatus 15 through the at least one mechanical filter outlet 63.

The mechanical filter apparatus 15 is periodically cleaned to discharge the solids accumulated in the mechanical filter chamber 70. The cleaning of the mechanical filter apparatus 15 is performed using the method(s) described herein. A portion of the wastewater discharged from the mechanical filter chamber 70 may be returned for further treatment within the wastewater treatment plant 1. In the present embodiment, a waste return line 83 is provided to return the wastewater discharged from the mechanical filter apparatus 15. A waste control valve 85 may optionally be provided to control the supply of waste to the waste return line 83. In the present embodiment, a portion of the waste from the mechanical filter chamber 70 is returned to the bioreactor 13. The waste returned from the mechanical filter apparatus 15 is typically in the form of a sludge (comprising or consisting of precipitated solid matter). The waste may be introduced into the bioreactor 13 through the bioreactor inlet 41 or a separate inlet. A portion of the waste discharged from the mechanical filter chamber 70 may be sent to waste or for further treatment downstream of the wastewater treatment plant 1.

In use, the mechanical filter elements 71 form a static filter pack 75 which is operative to filter solids from the wastewater. The mechanical filter elements 71 may have positive, negative or neutral buoyancy. The mechanical filter elements 71 have an open cell structure which provides a high retention capacity. The flow rate per unit cross sectional area of the static filter pack 75 may be less than 20 m3/m2/h exclusive, for example in the range 0.1 m3/m2/h to 19.9 m3/m2/h; 5 m3/m2/h to 19.5 m3/m2/h; or 11 m3/m2/h to 19 m3/m2/h. It has been recognised that these flow rates per unit cross-sectional area are particularly effective in the removal of flocs (also known as flocculant masses) from the wastewater. The flocs comprise or consist of loosely aggregated particles or soft flakes. At least in certain embodiments, the flocs can settle within the filter cells 73 of the mechanical filter elements 71 or on an exterior thereof. The relatively low flow rate through the static filter pack 75 helps to reduce or avoid disrupting the flocs. A higher flow rate could potentially cause certain types of flocs to break down or disintegrate into smaller flocs or individual particles. The treated water from the mechanical filter apparatus 15 may be discharged from the wastewater treatment plant 1 or sent to a receiving watercourse. Alternatively, the treated water may be sent for further treatment downstream.

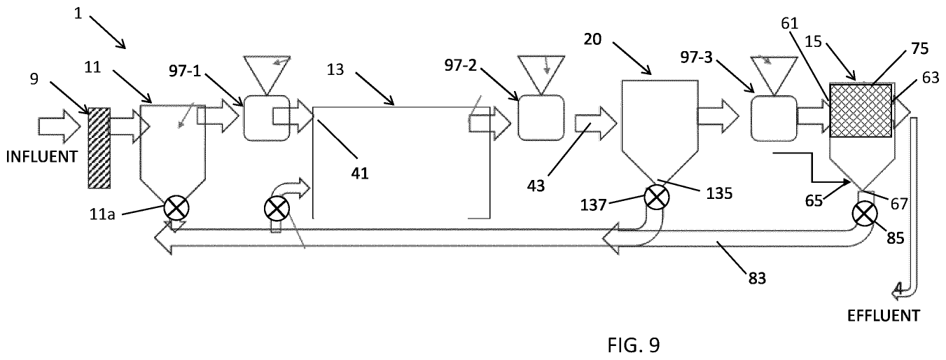

A variant of the wastewater treatment plant 1 shown in FIG. 8 will now be described with reference to FIG. 9. Like reference numerals are used for like components. The description focuses on the differences between the wastewater treatment plant 1 according to the present embodiment and the embodiment described with reference to FIG. 9.

The wastewater treatment plant 1 comprises a primary screen 9, a primary settlement tank 11, a bioreactor 13 and a mechanical filter apparatus 15. The wastewater treatment plant 1 may optionally comprise a tertiary settlement tank 20. The tertiary settlement tank 20 may be disposed between the bioreactor 13 and the mechanical filter apparatus 15. The bioreactor 13 comprises a moving bed bioreactor (MBBR) in the present embodiment. Other types of bioreactor 13 are contemplated. For example, the bioreactor 13 may comprise a submerged aerated filter (SAF) of the type described herein.

The wastewater treatment plant 1 comprises a first chemical dosing system 97-1, a second chemical dosing system 97-2 and a third chemical dosing system 97. The first chemical dosing system 97-1 is disposed upstream of the bioreactor 13. In the present embodiment, the first chemical dosing system 97-1 is disposed between the primary settlement tank 11 and the bioreactor 13. The second and third chemical dosing systems 97-2, 97-3 are disposed downstream of the bioreactor 13. The second chemical dosing system 97-2 is disposed between the bioreactor 13 and the tertiary settlement tank 20. The third chemical dosing system 97-3 is disposed between the tertiary settlement tank 20 and the mechanical filter apparatus 15. Each of the first, second and third chemical dosing systems 97-1, 97-2, 97-3 are configured to introduce a coagulating agent into the wastewater. The coagulating agent may cause one or more dissolved compounds, such as phosphate, to come out of solution and form particles. The coagulating agent promotes coagulation or agglomeration of the particles suspended in the wastewater. The coagulating agent may promote coagulation of particles in the wastewater, for example to form flocs. The wastewater treatment plant 1 may be modified to replace at least one of the first, second and third chemical dosing systems 97-1, 97-2, 97-3 with one or more electrocoagulation unit 91 of the type described herein.

The operation of the wastewater treatment plant 1 according to the present embodiment is consistent with the other embodiments described herein. The mechanical filter apparatus 15 is operative to filter particulates and flocs from the wastewater. The flow rate per unit cross sectional area of the static filter pack 75 may be less than 20 m3/m2/h exclusive, for example in the range 0.1 m3/m2/h to 19.9 m3/m2/h; 5 m3/m2/h to 19.5 m3/m2/h; or 11 m3/m2/h to 19 m3/m2/h. The mechanical filter media 69 may have a positive, neutral or negative buoyancy. In the present embodiment, the mechanical filter media 69 has a positive buoyancy.

The wastewater treatment plant 1 described herein may be a sewage treatment plant 1. The wastewater to be treated is in the form of sewage. The wastewater treatment plant 1 described herein may be a municipal sewage treatment plant 1 for treating municipal sewage. The sewage treatment plant 1 may, for example, process 1.2 million litres of wastewater each day. The wastewater treatment plant 1 should be capable of processing the wastewater to meet discharge consents in order to remain compliant with legislation. The discharge consents typically contain limits for pollutants including Biochemical Oxygen Demand (BOD), Total Suspended Solids (TSS), Phosphate (P), Nitrate (N) and ammonia in the form of Ammoniacal Nitrogen (NH3/N). The discharge consents are set by the water utility when water is received for treatment and by statutory bodes when discharged into the environment. The removal of macronutrients, such as Phosphate and Nitrate, are particularly important as these nutrients have a negative effect on receiving watercourses.

As described herein, the flow rate per unit cross-sectional area of the mechanical filter media 69 influences the filtration of the wastewater. The retention capacity of the mechanical filter apparatus 15 is dependent on the volume of the mechanical filter media 69 in the mechanical filter tank 60. To facilitate cleaning of the mechanical filter media 69, the filter media 69 preferably occupy approximately 40% to 60% by volume of the mechanical filter chamber 70. In a preferred embodiment, the filter media 69 occupy approximately 50% by volume of the mechanical filter chamber 70.

The mechanical filter apparatus 15 may comprise different sizes of mechanical filter tank 60. The mechanical filter tank 60 may comprise or consist of a cylindrical section having a circular cross-section. The mechanical filter tank 60 may have different cross-sections, for example polygonal, rectangular or square. The mechanical filter tank 60 may be oriented such that the central longitudinal axis extends vertically or horizontally. The mechanical filter chamber 70 formed in the mechanical filter tank 60 has a height (h) and a width (w). In the case of a mechanical filter tank 60 comprising or consisting of a cylindrical section, the width (w) corresponds to the diameter of the cylindrical section and the height (h) corresponds to the height of the cylindrical section (i.e., excluding any tapered or curved end sections). A ratio of the height (h) to the width (w) of the mechanical filter tank 60 is preferably in the range 1.5 to 2, inclusive. The ratio of the height (h) to the width (w) of the mechanical filter tank 60 is preferably in the range 1.75 to 2, inclusive. It has been determined that a mechanical filter tank 60 having this ratio of the height (h) to the width (w) is particularly effective if the mechanical filter media 69 occupies between 40% and 60% by volume of the mechanical filter chamber 70. A mechanical filter tank 60 having a height (h) equal to approximately twice its width (w) and containing 50% by volume of filter media 69 is particularly preferred. The filter pack formed in the mechanical filter chamber 70 by the mechanical filter media 69 preferably has a depth approximately equal to the width (w) of the mechanical filter tank 60.

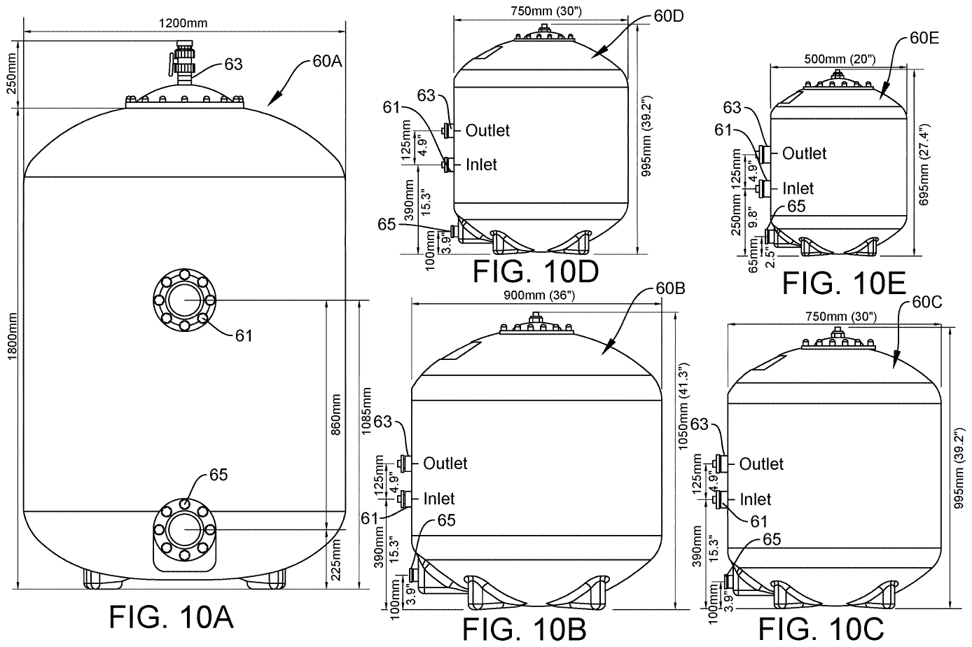

A first mechanical filter tank 60A is shown in FIG. 10A by way of example. The first mechanical filter tank 60 comprises a cylindrical section. The first mechanical filter tank 60 comprises a mechanical filter inlet 61, a mechanical filter outlet 63 and a mechanical filter waste outlet 67. The cylindrical section of the first mechanical filter tank 60A has a diameter of 1.2 m.

A second mechanical filter tank 60B is shown in FIG. 10B by way of example. The second mechanical filter tank 60 comprises a cylindrical section. The second mechanical filter tank 60B comprises a mechanical filter inlet 61, a mechanical filter outlet 63 and a mechanical filter waste outlet 67. The cylindrical section of the first mechanical filter tank 60B has a diameter of 0.9 m.

A third mechanical filter tank 60C is shown in FIG. 10C by way of example. The third mechanical filter tank 60 comprises a cylindrical section. The third mechanical filter tank 60C comprises a mechanical filter inlet 61, a mechanical filter outlet 63 and a mechanical filter waste outlet 67. The cylindrical section of the third mechanical filter tank 60C has a diameter of 0.75 m.

A fourth mechanical filter tank 60D is shown in FIG. 10D by way of example. The fourth mechanical filter tank 60 comprises a cylindrical section. The fourth mechanical filter tank 60D comprises a mechanical filter inlet 61, a mechanical filter outlet 63 and a mechanical filter waste outlet 67. The cylindrical section of the fourth mechanical filter tank 60D has a diameter of 0.6 m.

A fifth mechanical filter tank 60E is shown in FIG. 10E by way of example. The fourth mechanical filter tank 60 comprises a cylindrical section. The fourth mechanical filter tank 60E comprises a mechanical filter inlet 61, a mechanical filter outlet 63 and a mechanical filter waste outlet 67. The cylindrical section of the fourth mechanical filter tank 60E has a diameter of 0.5 m.

The mechanical filter apparatus 15 is sized in dependence on the flow rate of wastewater to be treated. The wastewater treatment plant 1 may be a sewage treatment plant configured to treat sewage. The sewage is typically defined with respect to a population equivalent (PE) representing a volume of wastewater per person (typically defined as 150 to 180 litres per day). The treater water from the wastewater treatment plant 1 must meet certain standards (defined in BSEN12566-3 in the UK). The standards may define thresholds for one or more of the following: Biochemical Oxygen Demand (BOD), suspended solids (SS) and ammonia (NH4-N) content. The BOD threshold may be defined as 20 mg/l (BOD of 20 mg/l). The suspended solids threshold may be defined as less than 30 mg/l (SS<30 mg/l). The ammonia threshold may be defined as less than 20 mg/l. There may be requirements in respect of other contaminants, such as Nitrates and Phosphates.

The operating parameters of a packaged (sewage) works are summarised in Table A below. The wastewater treatment plant 1 comprises at least one mechanical filter apparatus 15 of the type described herein for performing mechanical filtration of the wastewater discharged from the bioreactor 13. The number and size (diameter φ) of the mechanical filter apparatus 15 in the wastewater treatment plant 1 is summarised in the table. In this example, the wastewater treatment plant 1 comprises a single mechanical filter apparatus 15 having a diameter of 0.6 m.

TABLE A

| BOD | Population | Average flow | Mechanical Filter |
|---|---|---|---|
| (kg/day) | Equivalent (PE) | (litres per hour) | Requirement |
| 3 | <50 | 375 | 1 × φ0.6 m |

The operating parameters of a range of small (sewage) works are summarised in Table B below. The wastewater treatment plant 1 comprises at least one mechanical filter apparatus 15 of the type described herein for performing mechanical filtration of the wastewater discharged from the bioreactor 13. The number and size (diameter φ) of the mechanical filter apparatus 15 in the wastewater treatment plant 1 is summarised in the table.

TABLE B

| BOD | Population | Average flow | Mechanical Filter |
|---|---|---|---|
| (kg/day) | Equivalent (PE) | (litres per hour) | Requirement |
| ≤15 | 0-250 | 0-1875 | 1 × φ1.2 m |
| 15 to 30 | 250-500 | 1875-3750 | 1 × φ1.2 m |
| 30 to 120 | 500-2,000 | 3750-15,000 | 1 × φ1.2 m |
| 120 to 600 | 2,000-10,000 | 15,000-75,000 | 4 × φ1.2 m |
| 600 to 1,500 | 10,000-25,000 | 75,000-187,000 | 12 × φ1.2 m to |
| | | | 16 × φ1.2 m |

The operating parameters of a large (sewage) works are summarised in Table C below. The wastewater treatment plant 1 comprises at least one mechanical filter apparatus 15 of the type described herein for performing mechanical filtration of the wastewater discharged from the bioreactor 13. The number and size (diameter φ) of the mechanical filter apparatus 15 in the wastewater treatment plant 1 is summarised in the table. In this example, the wastewater treatment plant 1 comprises a single mechanical filter apparatus 15 having a diameter of 0.6 m.

TABLE C

| BOD | Population | Average flow | Mechanical Filter |
|---|---|---|---|
| (kg/day) | Equivalent (PE) | (litres per hour) | Requirement |
| >1,500 | >25,000 | >187,000 | Civil installation |
| | | | (>16 × φ1.2 m) |

It will be appreciated that various changes and modifications can be made to the present invention without departing from the scope of the present application.

Further aspects of the present invention(s) are set out in the following numbered paragraphs:
1. A wastewater treatment process for treating wastewater, the wastewater treatment process comprising:
   receiving wastewater for treatment;
   supplying the wastewater to a bioreactor comprising a biological filter media for performing biological filtration of the wastewater, the biological filter media comprising a plurality of biological filter elements for supporting colonies of microorganisms on a surface of the biological filter media the wastewater, wherein the biological filter elements are circulated within the bioreactor during filtration, the circulation of the biological filter elements causing solid waste to be dislodged from the biological filter elements and suspended in the wastewater;
   supplying the wastewater discharged from the bioreactor to a mechanical filter apparatus disposed downstream of the bioreactor, wherein the mechanical filter apparatus comprises a static filter pack for filtering the solid waste dislodged from the biological filter elements in the bioreactor and suspended in the wastewater, the static filter pack comprising a plurality of mechanical filter elements each having one or more filter cells; and
   discharging treated wastewater.
2. A wastewater treatment process as described in paragraph 1 comprising:
   supplying the wastewater to a settlement tank located upstream of the bioreactor for settlement of solids; and supplying the wastewater from the settlement tank to the bioreactor.
3. A wastewater treatment process as described in paragraph 1 or paragraph 2 comprising introducing pressurised air into the bioreactor to circulate the biological filter media within the bioreactor.
4. A wastewater treatment process as described in any one of the preceding paragraphs comprising periodically cleaning the mechanical filter apparatus to remove solid waste accumulated in the static filter pack, wherein cleaning the mechanical filter apparatus comprises disrupting the static filter pack to dislodge the solid waste accumulated in the mechanical filter elements.
5. A wastewater treatment process as described in paragraph 4, wherein the static filter pack is disrupted after closing at least one of a mechanical filter apparatus inlet for receiving wastewater from the bioreactor and a mechanical filter apparatus outlet for discharging the treated wastewater from the mechanical filter apparatus.
6. A wastewater treatment process as described in paragraph 4 or paragraph 5, wherein air is introduced into the mechanical filter apparatus at greater than atmospheric pressure to disrupt the static filter pack.
7. A wastewater treatment process as described in any one of paragraphs 4, 5 or 6 comprising opening a mechanical filter apparatus waste outlet to discharge at least some of the wastewater in the mechanical filter apparatus along with the solid waste dislodged from the mechanical filter elements.
8. A wastewater treatment process as described in any one of paragraphs 4 to 7, wherein at least some of the solid waste dislodged from the mechanical filter elements is re-introduced upstream of the bioreactor for further biological filtration.
9. A wastewater treatment process as described in paragraph 8, wherein the solid waste dislodged from the mechanical filter elements is introduced directly into the bioreactor.
10. A wastewater treatment process as described in paragraph 8 when dependent directly or indirectly on paragraph 2, wherein the solid waste dislodged from the mechanical filter elements is introduced into the settlement tank.
11. A wastewater treatment process as described in any one of the preceding paragraphs comprising using an electrocoagulation unit to agglomerate matter suspended in the wastewater.
12. A wastewater treatment process as described in paragraph 11, wherein the electrocoagulation unit is located upstream of the mechanical filter apparatus, the agglomerated matter being suspended in the wastewater introduced into the mechanical filter apparatus.
13. A wastewater treatment process as described in paragraph 11 or paragraph 12, wherein the electrocoagulation unit is located downstream of the bioreactor and agglomerating the solid waste dislodged from the biological filter elements in the bioreactor.
14. A wastewater treatment process for treating wastewater, the wastewater treatment process comprising:
   receiving wastewater for treatment;
   supplying the wastewater to a bioreactor comprising a biological filter media for performing biological filtration of the wastewater, the biological filter media comprising a plurality of biological filter elements for supporting colonies of microorganisms on a surface of the biological filter media the wastewater, wherein the biological filter elements are circulated within the bioreactor during filtration, the circulation of the biological filter elements causing solid waste to be dislodged from the biological filter elements and suspended in the wastewater;
   supplying the wastewater discharged from the bioreactor to an electrocoagulation unit to agglomerate the solid waste dislodged from the biological filter elements in the bioreactor; and
   discharging treated wastewater.
15. A wastewater treatment process for treating wastewater, the wastewater treatment process comprising:
   receiving wastewater for treatment;
   supplying the wastewater to an electrocoagulation unit to agglomerate solid matter suspended in the wastewater;
   supplying the wastewater from the electrocoagulation unit to a mechanical filter apparatus, wherein the mechanical filter apparatus comprises a static filter pack for filtering the agglomerated solid matter from the electrocoagulation unit, the static filter pack comprising a plurality of mechanical filter elements each having one or more filter cells; and
   discharging treated wastewater.
16. A wastewater treatment plant for treating wastewater, the wastewater treatment plant comprising:
   an inlet for receiving wastewater for treatment;
   a bioreactor comprising a biological filter media for performing biological filtration of the wastewater, the biological filter media being suitable for supporting colonies of microorganisms, the bioreactor comprising means for circulating the biological filter media within the bioreactor during filtration; and
   a mechanical filter apparatus disposed downstream of the bioreactor, wherein the mechanical filter apparatus comprises a static filter pack for filtering the solid waste dislodged from the biological filter elements in the bioreactor and suspended in the wastewater, the static filter pack comprising a plurality of mechanical filter elements each having one or more filter cells; and
   an outlet for discharging treated wastewater.
17. A wastewater treatment plant as described in paragraph 16 comprising:
   a settlement tank for promoting settlement of solids suspended in the wastewater, the settlement tank being located upstream of the bioreactor.
18. A wastewater treatment plant as described in paragraph 16 or paragraph 17 comprising a pressurised air supply for introducing pressurised air into the bioreactor to circulate the biological filter media within the bioreactor.
19. A wastewater treatment plant as described in any one of paragraphs 16, 17 or 18 comprising means for disrupting the static filter pack in the mechanical filter apparatus to dislodge the solid waste accumulated in the mechanical filter elements.
20. A wastewater treatment plant as described in paragraph 19 comprising one or more valves for closing at least one of a mechanical filter apparatus inlet and a mechanical filter apparatus outlet while the static filter pack is disrupted.
21. A wastewater treatment plant as described in paragraph 19 or paragraph 20, comprising a pressurised air supply for introducing air into the mechanical filter apparatus to disrupt the static filter pack.
22. A wastewater treatment plant as described in any one of paragraphs 19, 20 or 21 comprising a mechanical filter apparatus waste outlet operable to discharge at least some of the wastewater in the mechanical filter apparatus.
23. A wastewater treatment plant as described in paragraph 22 comprising a return line configured to return at least some of the wastewater from the mechanical filter apparatus for re-introduction into the wastewater treatment plant upstream of the bioreactor.
24. A wastewater treatment plant as described in paragraph 23, wherein the return line is connected to the bioreactor to return the wastewater from the mechanical filter apparatus into the bioreactor.
25. A wastewater treatment plant as described in paragraph 23 when dependent directly or indirectly on paragraph 17 wherein the return line is connected to the settlement tank to return the wastewater from the mechanical filter apparatus into the settlement tank.
26. A wastewater treatment plant as described in any one of paragraphs 16 to 25 comprising an electrocoagulation unit to agglomerate matter suspended in the wastewater.
27. A wastewater treatment plant as described in paragraph 26, wherein the electrocoagulation unit is located upstream of the mechanical filter apparatus; and, in use, the agglomerated matter is suspended in the wastewater introduced into the mechanical filter apparatus.
28. A wastewater treatment plant as described in paragraph 26 or paragraph 27, wherein the electrocoagulation unit is located downstream of the bioreactor and, in use, is operative to agglomerate solid waste suspended in the wastewater discharged from the bioreactor.
29. A wastewater treatment plant for treating wastewater, the wastewater treatment plant comprising:
   an inlet for receiving wastewater for treatment;
   a bioreactor comprising a biological filter media for performing biological filtration of the wastewater, the biological filter media being suitable for supporting colonies of microorganisms, the bioreactor comprising means for circulating the biological filter media within the bioreactor during filtration; and
   an electrocoagulation unit disposed downstream of the bioreactor, the electrocoagulation unit being configured to agglomerate matter suspended in the wastewater discharged from the bioreactor.
30. A wastewater treatment plant for treating wastewater, the wastewater treatment plant comprising:
   an inlet for receiving wastewater for treatment;
   an electrocoagulation unit to agglomerate solid matter suspended in the wastewater; and
   a mechanical filter apparatus disposed downstream of the electrocoagulation unit, wherein the mechanical filter apparatus comprises a static filter pack for filtering the agglomerated solid matter discharged from the electrocoagulation unit and suspended in the wastewater, the static filter pack comprising a plurality of mechanical filter elements each having one or more filter cells; and
   an outlet for discharging treated wastewater.

FIRST FLOW DIAGRAM LABELS

| | |
|---|---|
| 105 | INFLUENT WASTEWATER RECEIVED |
| 110 | (OPTIONALLY) PASS WASTEWATER THROUGH SETTLEMENT TANK |
| 115 | INTRODUCE WASTEWATER TO BIOREACTOR |
| 120 | BIOLOGICAL FILTRATION OF WASTEWATER PERFORMED IN |
| | BIOREACTOR |
| 125 | INTRODUCE WATER INTO MECHANICAL FILTER APPARATUS |
| 130 | MECHANICAL FILTRATION OF WASTEWATER USING MECHANICAL |
| | FILTER ELEMENTS HAVING ONE OR MORE OPEN FILTER CELLS |
| 135 | DISCHARGE TREATED WASTEWATER (EFFLUENT) |
| 140 | PERIODICALLY CLEAN MECHANICAL FILTER APPARATUS |
| 145 | DISRUPT FILTER PACK |
| 150 | DISCHARGE ACCUMMULATED WASTE |
| 155 | RE-CIRCULATE AT LEAST SOME OF DISCHARGED WASTE THROUGH |
| | BIOREACTOR |
| 160 | CONTINUE PROCESS |

SECOND FLOW DIAGRAM LABELS

| | |
|---|---|
| 205 | INFLUENT WASTEWATER RECEIVED |
| 210 | (OPTIONALLY) PASS WASTEWATER THROUGH SETTLEMENT TANK |
| 215 | INTRODUCE WASTEWATER TO BIOREACTOR |
| 220 | BIOLOGICAL FILTRATION OF WASTEWATER PERFORMED IN |
| | BIOREACTOR |
| 225 | INTRODUCE WATER INTO ELECTROCOAGULATION UNIT |
| 230 | ELECTROCOAGULATION UNIT AGGLOMERATES PARTICLES |
| 235 | DISCHARGE TREATED WATER FROM ELECTROCOAGULATION UNIT |
| 240 | INTRODUCE WATER INTO MECHANICAL FILTER APPARATUS |
| 245 | MECHANICAL FILTRATION OF WASTEWATER USING MECHANICAL |
| | FILTER ELEMENTS HAVING ONE OR MORE OPEN FILTER CELLS |
| 250 | DISCHARGE TREATED WASTEWATER (EFFLUENT) |
| 255 | PERIODICALLY CLEAN MECHANICAL FILTER APPARATUS |
| 260 | DISRUPT FILTER PACK |
| 265 | DISCHARGE ACCUMMULATED WASTE |
| 270 | RE-CIRCULATE AT LEAST SOME OF DISCHARGED WASTE THROUGH |
| | BIOREACTOR |
| 275 | CONTINUE PROCESS |

1-36. (canceled)

37. A wastewater treatment process for treating wastewater, the wastewater treatment process comprising the steps of:
receiving wastewater for treatment;
supplying the wastewater to a bioreactor for performing biological filtration of the wastewater;
supplying the wastewater discharged from the bioreactor to a mechanical filter apparatus disposed downstream of the bioreactor, wherein the mechanical filter apparatus comprises a static filter pack for filtering solid waste suspended in the wastewater, the static filter pack comprising a plurality of mechanical filter elements each having one or more filter cells; and
discharging treated wastewater.

38. The wastewater treatment process according to claim 38, wherein the bioreactor comprises:
a biological filter media for performing biological filtration of the wastewater, the biological filter media comprising a plurality of biological filter elements for supporting colonies of microorganisms on a surface of the biological filter media to perform biological filtration of the wastewater;
wherein the static filter pack in the mechanical filter apparatus filters the solid waste dislodged from the biological filter elements in the bioreactor and suspended in the wastewater discharged from the bioreactor.

39. The wastewater treatment process according to claim 38, wherein the biological filter elements are circulated within the bioreactor during filtration, the circulation of the biological filter elements causing solid waste to be dislodged from the biological filter elements and suspended in the wastewater discharged from the bioreactor.

40. The wastewater treatment process according to claim 39 further comprising the step of:
supplying the wastewater to a first settlement tank for settlement of solids, the first settlement tank being located upstream of the bioreactor; and
supplying the wastewater from the first settlement tank to the bioreactor.

41. The wastewater treatment process according to claim 40, wherein at least some of the solid waste accumulated in the mechanical filter apparatus is re-introduced into the first settlement tank.

42. The wastewater treatment process according to claim 41, further comprising the steps of:
supplying the wastewater from the bioreactor to a second settlement tank for settlement of solids, the second settlement tank being located downstream of the bioreactor; and
supplying the wastewater from the settlement tank to the mechanical filter apparatus.

43. The wastewater treatment process according to claim 42, further comprising the step of:
introducing pressurized air into the bioreactor to circulate the biological filter media within the bioreactor.

44. The wastewater treatment process according to claim 43, further comprising the step of:
periodically cleaning the mechanical filter apparatus to remove solid waste accumulated in the static filter pack, wherein cleaning the mechanical filter apparatus comprises disrupting the static filter pack to dislodge the solid waste accumulated in the mechanical filter elements.

45. The wastewater treatment process according to claim 44, wherein the static filter pack is disrupted after closing at least one of a mechanical filter apparatus inlet for receiving wastewater from the bioreactor and a mechanical filter apparatus outlet for discharging the treated wastewater from the mechanical filter apparatus.

46. The wastewater treatment process according to claim 45, wherein a pressurized fluid is introduced into the mechanical filter apparatus to disrupt the static filter pack.

47. The wastewater treatment process according to claim 46, further comprising the step of:
opening a mechanical filter apparatus waste outlet to discharge at least some of the wastewater in the mechanical filter apparatus along with the solid waste dislodged from the mechanical filter elements.

48. The wastewater treatment process according to claim 47, further comprising the step of:
re-introducing at least some of the solid waste accumulated in the mechanical filter apparatus into the bioreactor or upstream of the bioreactor for further biological filtration.

49. The wastewater treatment process according to claim 48, further comprising the step of:
using an electrocoagulation unit to agglomerate matter suspended in the wastewater.

50. The wastewater treatment process according to claim 49, wherein the electrocoagulation unit is located upstream of the mechanical filter apparatus, the agglomerated matter being suspended in the wastewater introduced into the mechanical filter apparatus.

51. The wastewater treatment process according to claim 50, wherein the electrocoagulation unit is located downstream of the bioreactor and agglomerating the solid waste dislodged from the biological filter elements in the bioreactor.

52. The wastewater treatment process according to claim 51, further comprising the step of:
introducing a coagulating agent into the wastewater upstream of the mechanical filter apparatus.

53. The wastewater treatment process according to claim 52, wherein the coagulating agent causes phosphate dissolved in the wastewater to come out of solution and form particles, the static filter pack of the mechanical filter apparatus filtering the particles formed by the coagulating agent.

54. The wastewater treatment process according to claim 53, wherein the coagulating agent causes the particles comprising or consisting of phosphate to agglomerate and form floes, the static filter pack of the mechanical filter apparatus filtering the floes from the wastewater.

55. The wastewater treatment process according to claim 54, comprising a flow rate per unit cross-sectional area of the static filter pack formed in the mechanical filter apparatus in the range 0.1 m3/m2/h to 19 m3/m2/h.
